(19) United States
(12) Patent Application Publication
(10) Pub. No.: US 2008/0009561 A1
(43) Pub. Date: Jan. 10, 2008

(54) Apparatus And Method To Prepare A Microsphere-Forming Composition

(75) Inventors: Evan C. Unger, Tucson, AZ (US); Varadarajan Ramaswami, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(73) Assignee: IMARX THERAPEUTICS, INC., Tucson, AZ (US)

(21) Appl. No.: 11/574,720

(22) PCT Filed: Sep. 6, 2005
(86) PCT No.: PCT/US05/31301

§ 371 Date: Mar. 5, 2007

Related U.S. Application Data
(60) Provisional application No. 60/607,205, filed on Sep. 3, 2004.

(51) Int. Cl. A61J 3/07; B01J 13/00; B01J 13/02; B32B 5/16

(52) U.S. Cl. 523/112

(57) ABSTRACT

A method is disclosed to prepare a microsphere-forming composition. The method provides a carbon-containing first solvent, where that first solvent is water soluble but does not comprise water The method further provides a second solvent comprising water, and (N) phosphorus-containing compounds, where (N) is greater or equal to than 1. The method forms a first mixture by mixing each of the (N) phosphorus-containing compound with the first solvent, and forms a second mixture comprising the second solvent and sodium chloride. The method then combines the first mixture and the second mixture to form the microsphere-forming composition.

### CROSS REFERENCE TO RELATED CASES

This application claims priority from a U.S. Provisional Application having Ser. No. 60/607,205 filed Sep. 3, 2004.

### FIELD OF THE INVENTION

The invention relates to a method to prepare a microsphere-forming composition, and to combine that microsphere-forming composition with one or more fluorine-containing gases.

### BACKGROUND OF THE INVENTION

Thrombosis, the formation and development of a blood clot or thrombus within the vascular system, can be life threatening. The thrombus can block a vessel and stop blood supply to an organ or other body part. If detached, the thrombus can become an embolus and occlude a vessel distant from the original site.

Dissolution of thrombus using ultrasound is known in the art. Further, the ability of microspheres comprising one or more fluorine-containing gases to potentiate ultrasound-induced thrombolysis is known. Those microspheres are destroyed by the ultrasound and the energy is released into the clot.

What is needed, however, is a cost-efficient method to prepare a microsphere-forming composition, and then combine that microsphere-forming composition with one or more fluorine-containing gases.

### SUMMARY OF THE INVENTION

Applicants' invention comprises a method to prepare a microsphere-forming composition. Applicants' method provides a carbon-containing first solvent, where that first solvent is water soluble but does not comprise water. The method further provides a second solvent comprising water, and (N) phosphorus-containing compounds, where (N) is greater or equal to than 2.

Applicants' method forms a first mixture by mixing each of the (N) phosphorus-containing compound with the first solvent, and forms a second mixture comprising the second solvent and sodium chloride. Applicants' method then combines the first mixture and the second mixture to form Applicants' microsphere-forming composition.

Applicants' invention further comprises an apparatus and method to combine Applicants' microsphere-forming composition with one or more fluorine-containing gases. The method provides (M) containers, where each of those (M) containers comprises an enclosed volume, where (M) is greater than 1. The method disposes Applicants' microsphere-forming composition in each of those (M) containers, such that the enclosed volume in each of said (M) containers comprises the microsphere-forming composition and head space.

Applicants' method further provides a gas/vacuum assembly comprising (M) fixturing mechanisms, and interconnected with a vacuum source and a source of one or more fluorine-containing gases. The method releaseably attaches each of the (M) containers to a different one of the (M) fixturing mechanisms, such that (i)th fixturing mechanism forms an air-tight seal with the (i)th container, where (i) is greater than or equal to 1 and less than or equal to (M).

The method reduces the pressure in the gas/vacuum assembly and in each of the (M) containers, and then introduces one or more fluorine-containing gases into the gas/vacuum assembly and into the head space of each of the (M) containers, where more than 90 weight percent of the introduced fluorine-containing gas is disposed in the (M) containers.

### BRIEF DESCRIPTION OF THE DRAWINGS

The invention will be better understood from a reading of the following detailed description taken in conjunction with the drawings in which like reference designators are used to designate like elements, and in which:

FIG. 1 is a flow chart summarizing a Applicants' method to prepare a microsphere-forming composition;

FIG. 2A is a cross-sectional view of one embodiment of Applicants' gas/vacuum apparatus, where that apparatus comprises one fixturing mechanism;

FIG. 2B is a cross-sectional view of one embodiment of Applicants' container, where that container can be releaseably attached to the fixturing mechanism of FIG. 2 to form an air-tight seal;

FIG. 2C shows certain dimensions for the container of FIG. 2B;

FIG. 2D shows the fixturing mechanism of FIG. 2A and the container of FIGS. 2B, wherein a stopper has been introduced into the container in a non-sealing orientation;

FIG. 2E shows the container of FIG. 2D wherein the stopper has been further introduced into the container to form a sealing orientation;

FIG. 3 shows the container of FIG. 2B releaseably attached to the fixturing mechanism of FIG. 2A;

FIG. 4 shows the container of FIG. 2B releaseably attached to the fixturing mechanism of FIG. 2A, where an interconnected vacuum source is being used to reduce the pressure inside the container;

FIG. 5 shows the container of FIG. 2B releaseably attached to the fixturing mechanism of FIG. 2A, where an interconnected fluorine-containing gas source is being used to introduce one or more fluorine-containing gases to the head space of the container;

FIG. 6 shows a graph depicting the pressure inside the container of FIGS. 4 and 5 versus time;

FIG. 7 shows a second embodiment of Applicants' gas/vacuum assembly, where that embodiment comprises a fluorine-containing gas recovery unit;

FIG. 8A shows one embodiment of a seal being disposed in the container of FIG. 5 after introduction of one or more fluorine-containing gases into the head space of that container;

FIG. 8B shows one embodiment of a stopper being disposed in the container of FIG. 5 after introduction of one or more fluorine-containing gases into the head space of that container;

FIG. 9 shows the container of FIG. 8A being released from Applicants' gas/vacuum apparatus;

FIG. 10 is a flow chart summarizing the steps of Applicants' method to combine Applicants' microsphere-forming composition and one or more fluorine-containing gases using the gas/vacuum apparatus of FIG. 2A;

FIG. 11 A shows a second embodiment of Applicants' gas/vacuum apparatus, wherein that apparatus comprises a processor and a first control network;

FIG. 11B shows a third embodiment of Applicants' gas/vacuum apparatus, wherein that apparatus comprises a processor and a second control network;

FIG. 11C shows a fourth embodiment of Applicants' gas/vacuum apparatus, wherein that apparatus comprises a processor and a third control network;

FIG. 12 is a flow chart summarizing a second embodiment of Applicants' method to form a microsphere-forming composition, and to combine that microsphere-forming composition with one or more fluorine-containing gases;

FIG. 13 is a flow chart summarizing a third embodiment of Applicants' method to form a microsphere-forming composition, and to combine that microsphere-forming composition with one or more fluorine-containing gases;

FIG. 14A is a block diagram showing the structure of a first block copolymer used in the method of FIG. 13; and

FIG. 14B is a block diagram showing the structure of a second block copolymer used in the method of FIG. 13.

### DETAILED DESCRIPTION OF THE PREFERRED EMBODIMENTS

This invention is described in preferred embodiments in the following description with reference to the Figures, in which like numbers represent the same or similar elements. Applicants' invention comprises a method to form a microsphere-forming composition, and to then combine that microsphere-forming composition with one or more fluorine-containing gasses. By “microsphere-forming composition,” Applicants mean a composition that can be combined with one or more fluorine-containing gases, and then shaken to form a plurality of microspheres comprising those one or more fluorine-containing gases.

By “microsphere,” Applicants mean a material comprising at least one internal void. In certain embodiments, Applicants' microspheres comprise a plurality of phosphorus-containing compounds. Those phosphorus-containing compounds form lipid-like structures in an aqueous medium. References herein to “lipids” refer to any combination of Applicants' plurality of phosphorus-containing compounds and/or block copolymers.

In any given microsphere, the lipids may be in the form of a monolayer or bilayer, and the mono- or bilayer lipids may be used to form one or more mono- or bilayers. In the case of more than one mono- or bilayer, the mono- or bilayers are generally concentric. The microspheres described herein include such entities commonly referred to as liposomes, micelles, bubbles, microbubbles, vesicles, and the like. Thus, the lipids may be used to form a unilamellar microsphere (comprised of one monolayer or bilayer), an oligolamellar microsphere (comprised of about two or about three monolayers or bilayers) or a multilamellar microsphere (comprised of more than about three monolayers or bilayers). The internal void of the microsphere is filled with a fluorine-containing gas; a perfluorocarbon gas, more preferably perfluoropropane or perfluorobutane; a hydrofluorocarbon gas; or sulfur hexafluoride; and may further contain a solid or liquid material, including, for example, a targeting ligand and/or a bioactive agent, as desired.

In certain embodiments, Applicants' plurality of phosphorus-containing compounds comprises dipalmitoylphosphatidylethanolaminepolyethylene glycol (“DPPE-PEG”), dipalmitoylphosphatidylcholine (“DPPC”), and dipalmitoylphosphatidic acid (“DPPA”). As those skilled in the art will appreciate, each of Applicants' phosphorus-containing compounds is structurally similar to naturally-occurring lipid/phosolipid materials. As those skilled in the art will further appreciate, lipids comprise a polar, i.e. hydrophilic, head and one to three nonpolar, i.e. hydrophobic, tails. Phospholipids comprise materials having a hydrophilic head which includes a positively charged group linked to the tail by a negatively charged phosphate group.

In certain embodiments, Applicants' method further provides a plurality of carbon-containing liquids and a plurality of salts. In certain embodiments, Applicants' plurality of carbon-containing liquids includes propylene glycol and glycerol. In certain embodiments, Applicants' plurality of salts includes sodium chloride, sodium phosphate monobasic, sodium phosphate dibasic.

In certain embodiments, Applicants' method forms a first mixture comprising the plurality of phosphorus-containing compounds in a first solvent, wherein that first solvent comprises one or more carbon atoms, and wherein that first solvent is water soluble, and wherein that first solvent does not comprise water.

In certain embodiments, Applicants' first mixture comprises a solution. In certain embodiments, Applicants' first solvent is infinitely water soluble. In certain embodiments, Applicants' first solvent comprises a polyol. In certain embodiments, Applicants' first solvent comprises propylene glycol. In certain embodiments, Applicants' first solvent consists essentially of propylene glycol.

Applicants' method forms a second mixture comprising a plurality of inorganic salts in a second solvent. In certain embodiments, Applicants' second mixture comprises a solution. In certain embodiments, Applicants' second solvent is water soluble. In certain embodiments, Applicants' second solvent is infinitely water soluble. In certain embodiments, Applicants' second solvent comprises water in combination with a carbon-containing liquid. In certain embodiments, that carbon-containing liquid comprises glycerol.

Applicants' method then combines the mixture comprising the plurality of phosphorus-containing compounds with the inorganic salt mixture to form Applicants' microsphere-forming composition. In certain embodiments, Applicants' microsphere-forming composition has a pH between about 5 and about 8. In certain embodiments, Applicants' microsphere-forming composition has a pH of about 6.5.

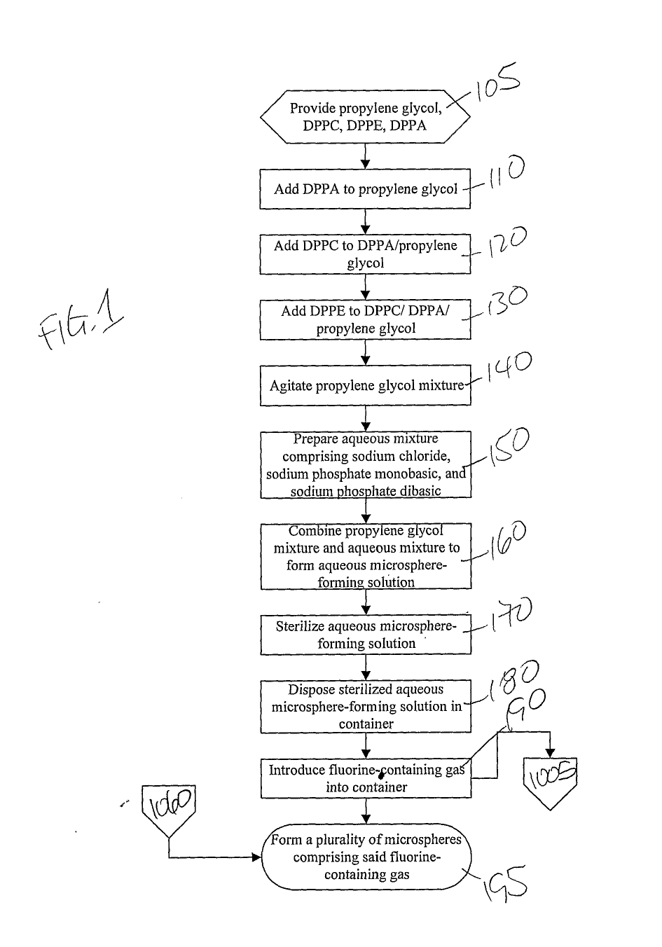

FIG. 1 recites the steps in one embodiment of Applicants' method to form their microsphere-forming composition. In step 105, Applicants' method provides propylene glycol, dipalmitoylphosphatidylethanolaminepolyethylene glycol (“DPPE-PEG”), dipalmitoylphosphatidylcholine (“DPPC”), and dipalmitoylphosphatidic acid (“DPPA”).

In certain embodiments, the DPPE-PEG comprises a polyethylene glycol (PEG) moiety having a number average molecular weight between about 400 daltons and about 200,000 daltons. In certain embodiments, the DPPE-PEG comprises a PEG moiety having a number average molecular weight between about 1,000 daltons and about 20,000 daltons. In certain embodiments, the DPPE-PEG comprises a polyethylene glycol (PEG) moiety having a number average molecular weight about 5,000 daltons.

In certain embodiments, the DPPE-PEG comprises a polyethylene glycol (PEG) moiety having a weight average molecular weight between about 400 daltons and about 200,000 daltons. In certain embodiments, the DPPE-PEG comprises a PEG moiety having a weight average molecular weight between about 1,000 daltons and about 20,000 daltons. In certain embodiments, the DPPE-PEG comprises a polyethylene glycol (PEG) moiety having a weight average molecular weight about 5,000 daltons.

By “polyethylene glycol moiety,” Applicants mean a material formed by the polymerization of oxirane, sometimes referred to as ethylene oxide, where that polymerization is effected using any method known to those skilled in the art, for example and without limitation anionic polymerization, cationic polymerization, transition metal polymerization, and the like.

In step 110, Applicants' method adds DPPA to a first solvent disposed in a first vessel. In certain embodiments, that first solvent is a water-soluble organic solvent. By “organic solvent,” Applicants mean a material that is a liquid at room temperature and that comprises at least one carbon atom.

In certain embodiments, that first solvent is propylene glycol. In certain embodiments, the propylene glycol is disposed in a first vessel and heated prior to addition of the DPPA. In certain embodiments, the propylene glycol is heated to between about 55° C. and about 75° C. prior to addition of the DPPA. In certain embodiments, the propylene glycol is agitated during and/or after the addition of the DPPA. In certain embodiments, the propylene glycol is heated and agitated during and after the addition of the DPPA.

In step 120, Applicant's method adds DPPC to the first mixture of step 110 to form a second mixture. In certain embodiments, the first mixture of step 110 is heated prior to addition of the DPPC. In certain embodiments, the first mixture of step 110 is heated to between about 55° C. and about 75° C. prior to addition of the DPPC. In certain embodiments, the first mixture is agitated during and/or after the addition of the DPPC. In certain embodiments, the first mixture is heated and agitated during and after the addition of the DPPC.

In step 130, Applicants' method adds DPPE-PEG to the second mixture of step 120 to form a third mixture. In certain embodiments, the second mixture of step 110 is heated prior to addition of the DPPE-PEG. In certain embodiments, the second mixture of step 120 is heated to between about 55° C. and about 75° C. prior to addition of the DPPE-PEG. In certain embodiments, the second mixture is agitated during and/or after the addition of the DPPE-PEG. In certain embodiments, the second mixture is heated and agitated during and after the addition of the DPPE-PEG.

In the illustrated embodiment of FIG. 1, DPPA is added to the first solvent and DPPC and DPPE-PEG are subsequently added. In other embodiments, DPPC is added to the first solvent and DPPA and DPPE-PEG are subsequently added. In still there embodiments, DPPE-PEG is added to the first solvent and DPPA and DPPC are subsequently added.

In certain embodiments of Applicants' method, Applicants' plurality of phosphorus-containing compounds comprises between about 1 weight percent and about 30 weight percent DPPA, between about 30 weight percent and about 60 weight percent DPPE-PEG, and between about 40 weight percent and about 70 weight percent DPPC. In certain embodiments of Applicants' method, Applicants' plurality of phosphorus-containing compounds comprises between about 3 weight percent and about 10 weight percent DPPA, between about 35 weight percent and about 50 weight percent DPPE-PEG, and between about 47 weight percent and about 65 weight percent DPPC. In certain embodiments of Applicants' method, Applicants' plurality of phosphorus-containing compounds comprises about 6 weight percent DPPA, about 40 weight percent DPPE-PEG, and about 54 weight percent DPPC.

In step 140, the mixture comprising Applicants' plurality of phosphorus-containing materials and the first solvent is agitated. In certain embodiments, step 140 includes mechanical stirring. In certain embodiments, step 140 includes ultrasonic mixing. In certain embodiments, step 140 includes agitating the vessel containing Applicants' mixture of phosphorus-containing materials and the first solvent.

In step 150, Applicants' method prepares in a second vessel an aqueous mixture of sodium chloride, sodium phosphate monobasic, and sodium phosphate dibasic. In certain embodiments, the aqueous mixture of step 150 further includes an organic solvent. In certain embodiments, that organic solvent is water soluble.

In step 160, Applicants' method combines Applicants' mixture comprising a plurality of phosphorus-containing materials in the first solvent formed in steps 110-140 with the aqueous mixture of step 150 to form Applicants' microsphere-forming composition. In certain embodiments, the mixture comprising a plurality of phosphorus-containing materials in the first solvent is heated before combining that mixture with the aqueous mixture of step 150. In certain embodiments, the mixture comprising a plurality of phosphorus-containing materials in the first solvent is heated to between about 55° C. and about 75° C. before combining that mixture with the aqueous mixture of step 150.

In certain embodiments, the aqueous mixture of step 150 is heated before being combined with Applicants' mixture comprising a plurality of phosphorus-containing materials in the first solvent. In certain embodiments, the aqueous mixture of step 150 is heated to between about 55° C. and about 75° C. before being combined with Applicants' mixture comprising a plurality of phosphorus-containing materials in the first solvent.

In certain embodiments, both the mixture comprising a plurality of phosphorus-containing materials in the first solvent and the aqueous mixture of step 150 are heated before combining those mixtures. In certain embodiments, both the mixture comprising a plurality of phosphorus-containing materials in the first solvent and the aqueous mixture of step 150 are heated to between about 55° C. and about 75° C. before combining those mixtures.

In certain embodiments, the plurality of phosphorus-containing materials in the first solvent is added to aqueous mixture of step 150. In other embodiments, In certain embodiments, the aqueous mixture of step 150 is added to the plurality of phosphorus-containing materials in the first solvent.

The invention of steps 105 through 140 is further demonstrated in the following actual Example. This example, however, is not intended to in any way limit the scope of the present invention.

### EXAMPLE

1. Dispose 100 mL of propylene glycol in a first vessel;

2. Place first vessel in an oil bath maintained at 60° C.±5° C.;

3. Add 60 milligrams of DPPA to the heated propylene glycol;

4. After dissolution of the DPPA, add 540 milligrams of DPPC to the heated propylene glycol solution;

5. After dissolution of the DPPA, add 400 milligrams of DPPE-PEG5000 to the heated propylene glycol solution;

6. After dissolution of the DPPE-PEG5000, stir heated propylene glycol solution using a Silverson high-speed stirrer at 3500 RMP for 5 minutes;

7. Dispose 850 mL of water in a second vessel;

8. Place second vessel in an oil bath maintained at 60° C.±5° C.;

9. Add 50 mL of glycerol to heated water in second vessel;

10. Mix water/glycerol mixture using a magnetic stir bar for about 15 minutes;

11. Add 4.87 grams of sodium chloride to heated water/glycerol mixture;

12. Add 2.34 grams of sodium phosphate monobasic to the heated sodium chloride/water/glycerol mixture;

13. Add 2.16 grams of sodium phosphate dibasic to the heated sodium phosphate monobasic/sodium chloride/water/glycerol mixture;

14. Stir aqueous mixture until dissolution of all added salts;

15. Add the contents of the first vessel to the heated second vessel with stirring to form the microsphere-forming composition;

16. Maintain the microsphere-forming composition at 60° C.±5° C. until aseptic filtration.

Referring again to FIG. 1, in step 170 Applicants' method sterilizes the composition of step 160. Sterilization provides a composition that may be readily administered to a patient via a variety of routes. In certain embodiments, the sterilization of step 170 is accomplished by aseptic filtration. In certain embodiments, the sterilization of step 170 is accomplished using moist heat (steam) and/or gamma irradiation.

In certain embodiments, step 170 includes aseptically filtering Applicants' microsphere-forming solution. In certain embodiments step 170 includes extruding the microsphere-forming solution through at least one filter of a selected pore size, where the pore size may be smaller than 10 microns, preferably about 0.22 microns.

In step 180, Applicants' method aseptically disposes the sterilized microsphere-forming composition into a container. In certain embodiments, the container of step 180 comprises a vial which will subsequently be sold in commerce. In certain embodiments, that vial has a capacity of about 1.5 mL. In certain embodiments, that vial has a capacity of about 3 mL. In other embodiments, the container of step 180 has a capacity between about 1 mL and about 50 mL.

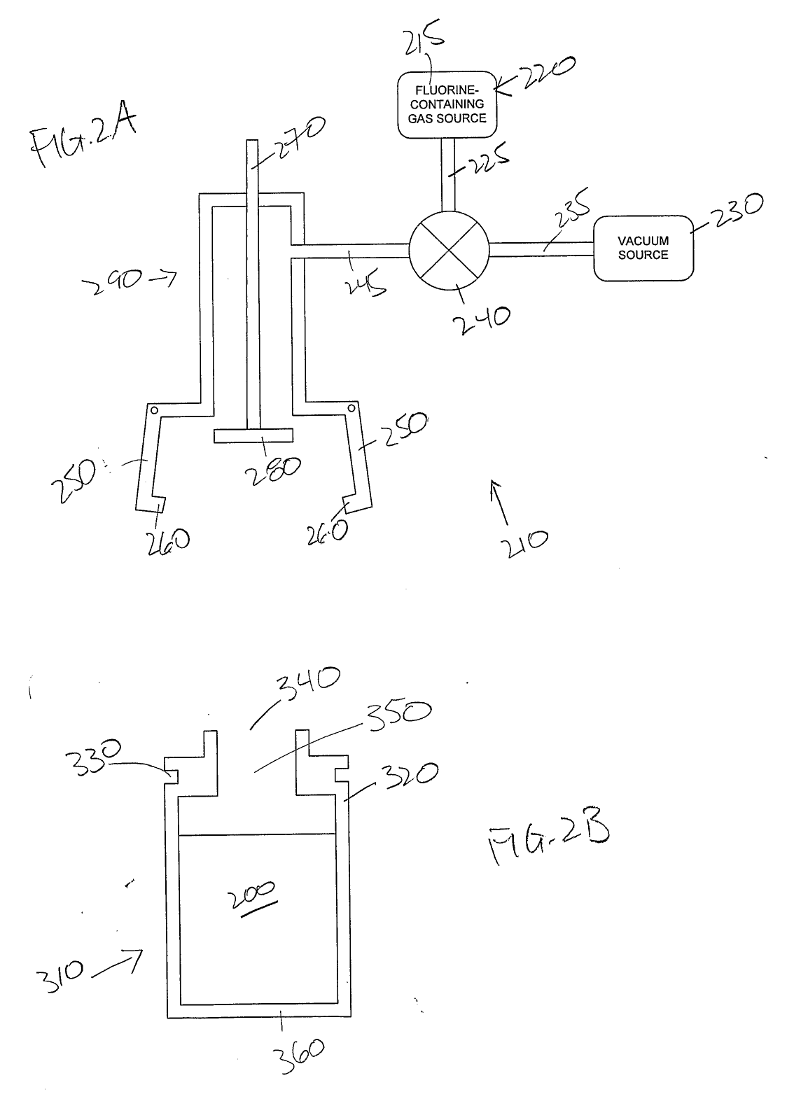

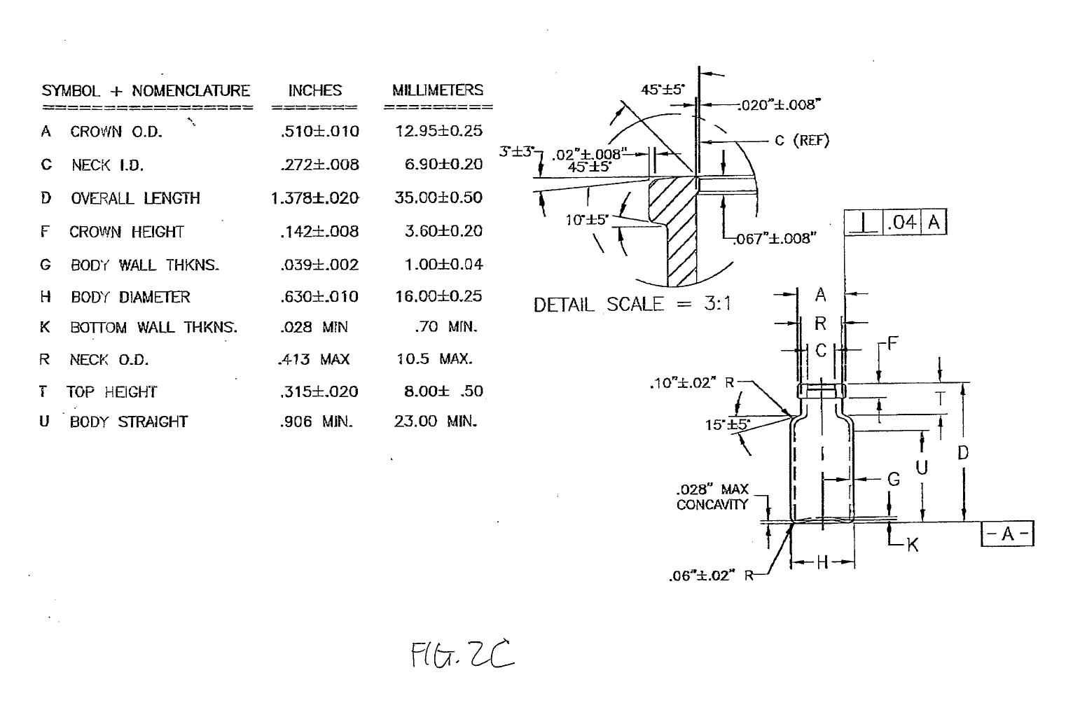

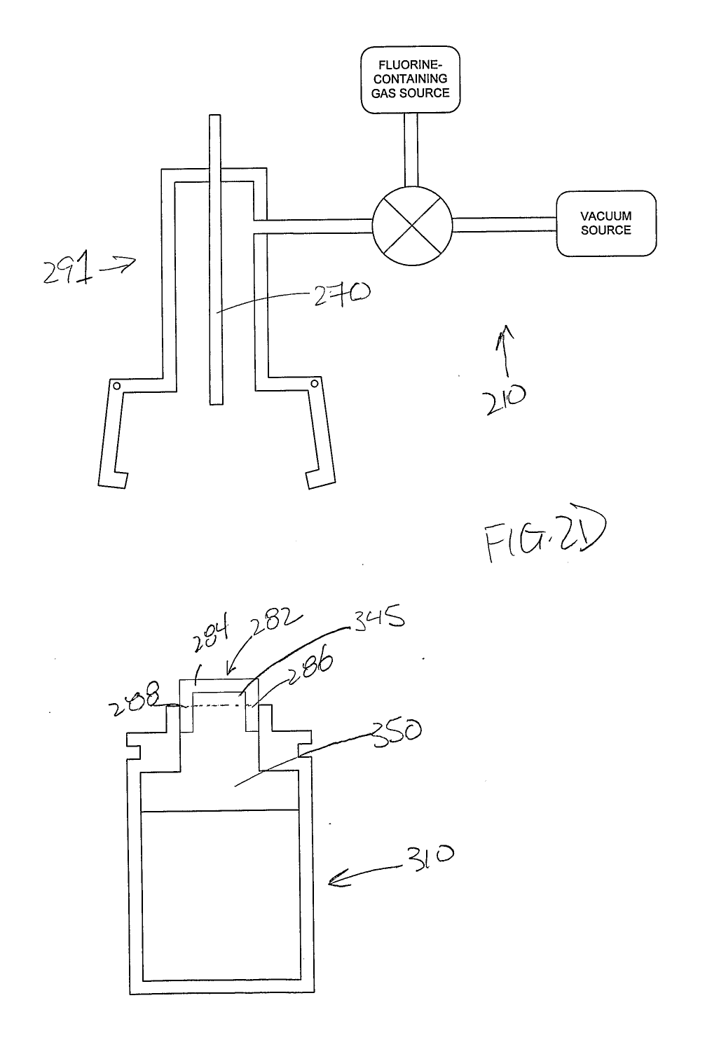

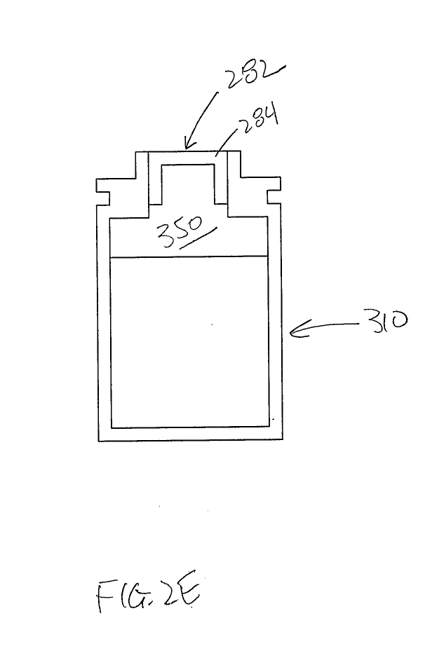

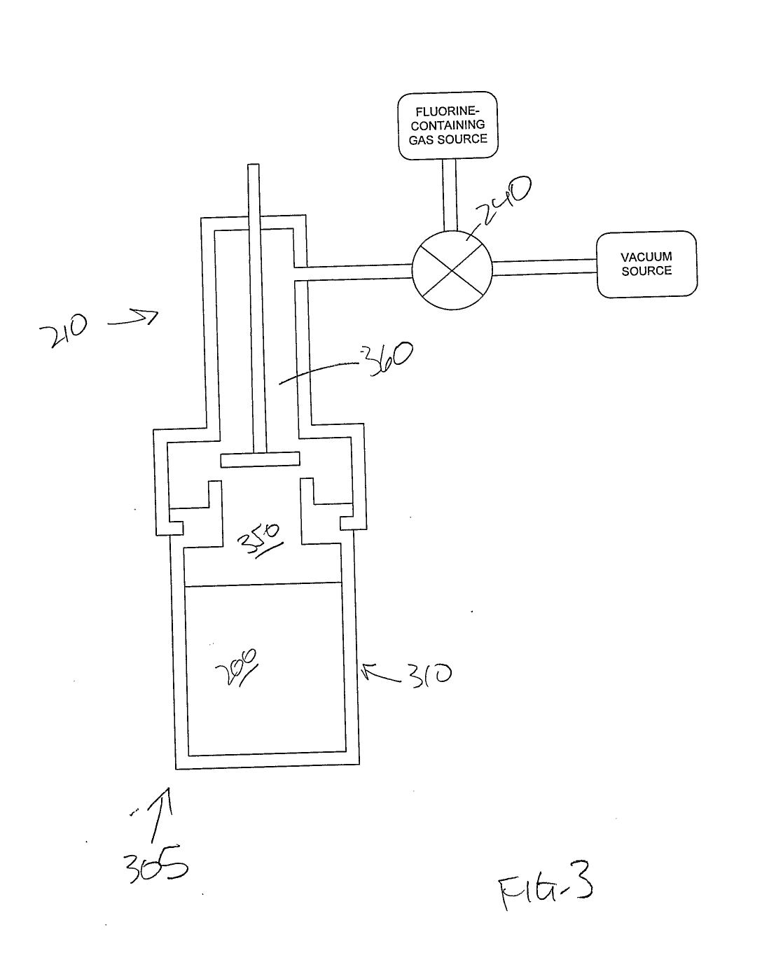

Referring now to FIG. 2B, in certain embodiments the container of step 180 comprises vessel 310. Vessel 310 includes bottom 360, one or more walls 320 each of which is attached to bottom 360 such that each of those one or more walls is continuously attached to each neighboring wall, and such that those continuously attached walls extend upwardly from bottom 360 to define an enclosed space 350 which is formed to include aperture 340. Vessel 310 is formed to include groove 330, wherein groove 330 is formed on the exterior surface of vessel 310 adjacent aperture 340. Vessel 310 is sometimes described as comprising a neck and a crown, which in combination define groove 330.

In the illustrated embodiments of FIGS. 2B and 2C, vessel 310 includes Applicants' microsphere-forming composition 200 formed in step 160 (FIG. 1). FIG. 2C shows certain dimensions for one embodiment of vessel 310.

In the illustrated embodiment of FIG. 2B, vessel 310 comprises a circular cross-section. In this embodiment, vessel 310 includes a single, continuous wall 320 which in combination with bottom 360 defines a cylinder. In other embodiments, vessel 310 comprises a square cross-section defined by 4 walls, a pentagonal cross-section defined by 5 walls, a hexagonal cross-section defined by 6 walls, and the like.

Referring again to FIG. 1, in step 190 Applicants' method introduces one or more fluorine-containing gases into the vessel containing Applicants' microsphere-forming composition. In certain embodiments, step 190 includes placing one or more vessels containing Applicants' microsphere-forming solution in a chamber, which chamber may be pressurized, and introducing the fluorine-containing gas into that chamber such that the head space of the vessel is filled with that fluorine-containing gas. In certain embodiments, step 190 includes evacuating, i.e. reducing the pressure in, the chamber containing Applicants' one or more vessels before introduction of the fluorine-containing gas therein. In certain embodiments, step 190 includes sequentially evacuating the chamber and thereafter introducing fluorine-containing gas into that chamber having a reduced internal pressure (N) times, wherein (N) is greater than or equal to 1 and less than or equal to about 4.

In certain embodiments, the fluorine-containing gas comprises one or more perfluorocarbons. In certain embodiments, those one or more perfluorocarbons are selected from the group consisting of perfluoropropane, perfluorobutane, perfluoropentane, and perfluorohexane. In certain embodiments, the fluorine-containing gas comprises sulfur hexafluoride in combination with one or more perfluorocarbons.

In step 195, Applicants' method forms a plurality of microspheres containing the fluorine-containing gas. In certain embodiments, step 195 includes shaking the vessel containing Applicants' microsphere-forming composition and the fluorine-containing gas to form a plurality of microspheres comprising that fluorine-containing gas. Preferably, the vessel is shaken at a temperature below the gel to liquid crystalline phase transition temperature of the lipid to form a fluorine-containing gas-filled microsphere. Step 195 comprises an end-user operation, wherein step 195 is performed just prior to clinical use of Applicants' gas-filled microsphere composition.

In certain embodiments, Applicants' gas-filled microspheres of step 195 comprise dipalinitoylphosphatidylcholine, dipalmitoylphosphatidylethanolamine-polyethylene glycol, and dipalmitoylphosphatidic acid, in combination with one or more fluorine-containing gases. In certain embodiments, Applicants' gas-filled microsphere composition of step 195 comprises a plurality of Applicants' gas-filled microspheres disposed in an aqueous-based pharmaceutically acceptable carrier. The combined concentration of gas-filled microspheres in Applicants' composition is between about 0.1 mg/ml and about 5 mg/ml of the pharmaceutically acceptable carrier.

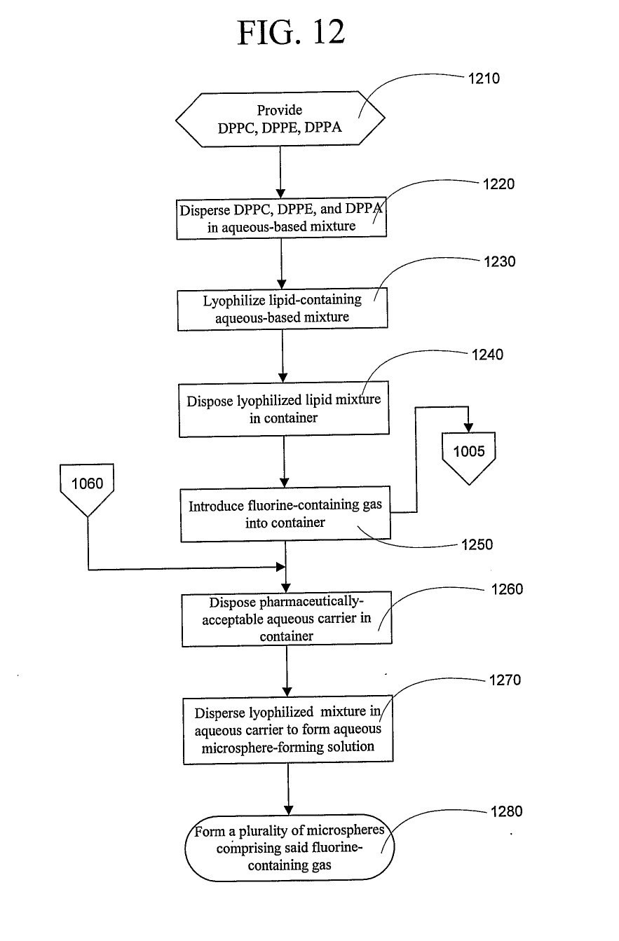

Referring now to FIG. 12, in certain embodiments Applicants' method disperses a mixture of Applicants' phosphorus-containing compounds in an aqueous-based carrier. In certain embodiments, Applicants' plurality of phosphorus-containing compounds includes dipalmitoylphosphatidylethanolaminepolyethylene glycol (“DPPE-PEG”), dipalmitoylphosphatidylcholine (“DPPC”), and dipalmitoylphosphatidic acid (“DPPA”). In certain embodiments, Applicants' aqueous-based carrier comprises water, buffer, normal saline, physiological saline, and the like, as well as other aqueous carriers readily apparent to those skilled in the art.

That aqueous lipid mixture is then lyophilized to form a lipid composition such that the ratio of lipids in the lipid composition is consistent throughout the composition. That lipid composition is then disposed in a vessel, and one or more fluorine-containing gases are introduced into that vessel after which the vessel is sealed. Subsequently, a pharmaceutically acceptable aqueous carrier is introduced into the vessel, and the lyophilized composition is dispersed in that aqueous pharmaceutically acceptable carrier to a concentration of about 0.1 mg/ml to about 5 mg/ml to form Applicants' microsphere-forming solution. The vessel is then agitated to form Applicants' gas-filled microsphere composition.

FIG. 12 summarizes the steps of this embodiment of Applicants' method to form gas-filled microspheres. Referring now to FIG. 12, in step 1210 Applicants' method provides a plurality of phosphorus-containing materials. In certain embodiments, Applicants' phosphorus-containing compounds include DPPA-PEG, DPPC, and DPPA, as described above. In certain embodiments, Applicants' plurality of phosphorus-containing compounds comprises between about 1 weight percent and about 30 weight percent DPPA, between about 30 weight percent and about 60 weight percent DPPE-PEG, and between about 40 weight percent and about 70 weight percent DPPC. In certain embodiments of Applicants' method, Applicants' plurality of phosphorus-containing compounds comprises between about 3 weight percent and about 10 weight percent DPPA, between about 35 weight percent and about 50 weight percent DPPE-PEG, and between about 47 weight percent and about 65 weight percent DPPC. In certain embodiments of Applicants' method, Applicants' plurality of phosphorus-containing compounds comprises about 6 weight percent DPPA, about 40 weight percent DPPE-PEG, and about 54 weight percent DPPC.

In step 1220, Applicants' method disperses the lipids dipalmitoylphosphatidylcholine, dipalmitoylphosphatidylethanolamine-polyethylene glycol, and dipalmitoylphosphatidic acid in an aqueous-based carrier to a concentration of about 25 mg/ml to form a lipid-containing aqueous solution. In certain embodiments, Applicants' aqueous-based carrier comprises water, buffer, normal saline, physiological saline, and the like, as well as other aqueous carriers readily apparent to those skilled in the art.

In step 1230, Applicants' method lyophilizes the lipid-containing aqueous mixture of step 1220. By “lyophilize,” Applicants mean the preparation of a lipid composition in dry form by rapid freezing and dehydration in the frozen state (sometimes referred to as sublimation). Lyophilization takes place at a temperature which results in the crystallization of the lipids to form a lipid matrix. This process may take place under vacuum at a pressure sufficient to maintain frozen product with the ambient temperature of the containing vessel at about room temperature, preferably less than about 500 mTorr, more preferably less than about 200 mTorr, even more preferably less than about 1 mTorr.

The step of lyophilizing the aqueous-based lipid solution includes freezing and dehydration. The mixture of step 1220 is frozen and dehydrated at a temperature of from about −50° C. to about 25° C., preferably from about −20° C. to about 25° C., even more preferably from about 10° C. to about 25° C. This temperature range includes and is not limited to placing the lipid solution on dry ice and in liquid nitrogen. The lyophilization preferably takes place under vacuum, at a pressure sufficient to maintain frozen product with the ambient temperature of the containing vessel at about room temperature, preferably less than about 1 mTorr.

For large preparations of lipid compositions, such as about two liters at a concentration of about 25 mg/ml, the lyophilization step takes about 16 hours to about 72 hours, more preferably about 24 hours to about 96 hours, even more preferably about 16 hours to about 24 hours to complete. As a result of lyophilization, the composition is easy to redisperse in another aqueous carrier, such as a pharmaceutically acceptable carrier. Lyophilization also contributes, in whole or in part, to the consistency of the ratio of lipids throughout the composition.

In step 1240, Applicants' method disposes the lyophilized lipid mixture of step 1230 in a container. In certain embodiments, the container of step 1230 comprises vessel 310 (FIGS. 2B, 2C), described above.

In step 1250, Applicants' method introduces one or more fluorine-containing gases into the vessel containing Applicants' lyophilized lipid composition. In certain embodiments, step 1250 includes placing one or more vessels containing Applicants' lyophilized lipid composition in a chamber, which chamber may be pressurized, and introducing the fluorine-containing gas into that chamber such that the head space of the vessel is filled with that fluorine-containing gas. In certain embodiments, step 1250 includes evacuating, i.e. reducing the pressure in, the chamber containing Applicants' one or more vessels before introduction of the fluorine-containing gas therein. In certain embodiments, step 1250 includes sequentially evacuating the chamber and thereafter introducing fluorine-containing gas into that chamber having a reduced internal pressure (N) times, wherein (N) is greater than or equal to 1 and less than or equal to about 4.

In certain embodiments, the fluorine-containing gas comprises one or more perfluorocarbons. In certain embodiments, those one or more perfluorocarbons are selected from the group consisting of perfluoropropane, perfluorobutane, perfluoropentane, and perfluorohexane. In certain embodiments, the fluorine-containing gas comprises sulfur hexafluoride in combination with one or more perfluorocarbons.

In step 1260, Applicants' method disposes a pharmaceutically-acceptable carrier into the vessel containing Applicants' lyophilized lipid composition and the one or more fluorine-containing gases. The pharmaceutically acceptable aqueous-based carrier of step 1260 may comprise water, buffer, normal saline, physiological saline, a mixture of water, glycerol, and propylene glycol or a mixture of saline, glycerol, and propylene glycol where the components of the mixtures are in a ratio of 8:1:1 or 9:1:1, v:v:v, a mixture of saline and propylene glycol in a ratio of 9:1, v:v, and the like.

In step 1270, Applicants' method disperses the lyophilized lipid composition of step 1230 in the pharmaceutically-acceptable carrier of step 1260 to form Applicants' microsphere-forming composition. In certain embodiments, step 1270 includes agitating the vessel containing Applicants' lyophilized lipid composition, the pharmaceutically-acceptable carrier, and the one or more fluorine-containing gases. In certain embodiments, steps 1260 and 1270 are performed synchronously.

In step 1280, the method forms Applicants' gas-filled microsphere composition. In certain embodiments, step 1280 includes agitating the vessel containing Applicants' microsphere-forming composition and the one or more fluorine-containing gases. In certain embodiments, steps 1260, 1270, and 1280, are performed synchronously.

In certain embodiments, steps 1270 and 1280 comprise end-user operations, wherein those steps are performed just prior to clinical use of Applicants' gas-filled microsphere composition. In certain embodiments, steps 1260, 1270, and 1280 comprise end-user operations, wherein those steps are performed just prior to clinical use of Applicants' gas-filled microsphere composition.

In certain embodiments, Applicants' gas-filled microspheres of step 1280 comprise dipalmitoylphosphatidylcholine, dipalmitoylphosphatidylethanolamine-polyethylene glycol, and dipalmitoylphosphatidic acid, in combination with one or more fluorine-containing gases. In certain embodiments, Applicants' gas-filled microsphere composition of step 1280 comprises a plurality of Applicants' gas-filled microspheres disposed in an aqueous-based pharmaceutically acceptable carrier. The combined concentration of gas-filled microspheres in Applicants' composition is between about 0.1 mg/ml and about 5 mg/ml of the pharmaceutically acceptable carrier.

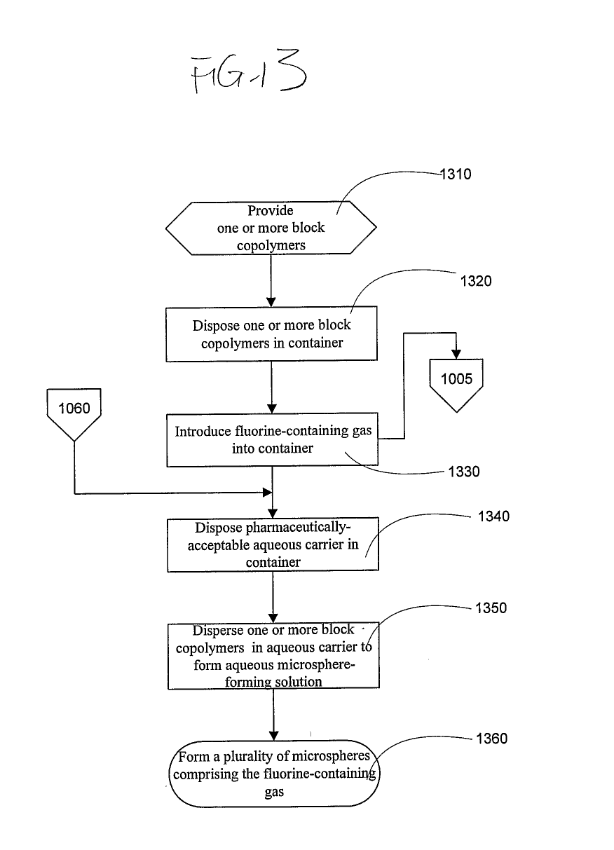

Referring now to FIG. 13, in certain embodiments Applicants' method provides one or more block copolymers. Those one or more block copolymers are disposed in a vessel, and one or more fluorine-containing gases are introduced into that vessel after which the vessel is sealed. Subsequently, a pharmaceutically acceptable aqueous carrier is introduced into the vessel, and the one or more block copolymers are dispersed in that aqueous pharmaceutically acceptable carrier to a concentration of about 0.1 mg/ml to about 5 mg/ml to form Applicants' microsphere-forming solution. The vessel is then agitated to form Applicants' gas-filled microsphere composition.

FIG. 13 summarizes the steps of this embodiment of Applicants' method to form gas-filled microspheres. Referring now to FIG. 13, in step 1310 Applicants' method provides one or more block copolymers. In certain embodiments, one or more of those block copolymers comprises a star structure. By “star structure,” Applicants mean a material comprising a core and 3 or more branches or arms extending from that core.

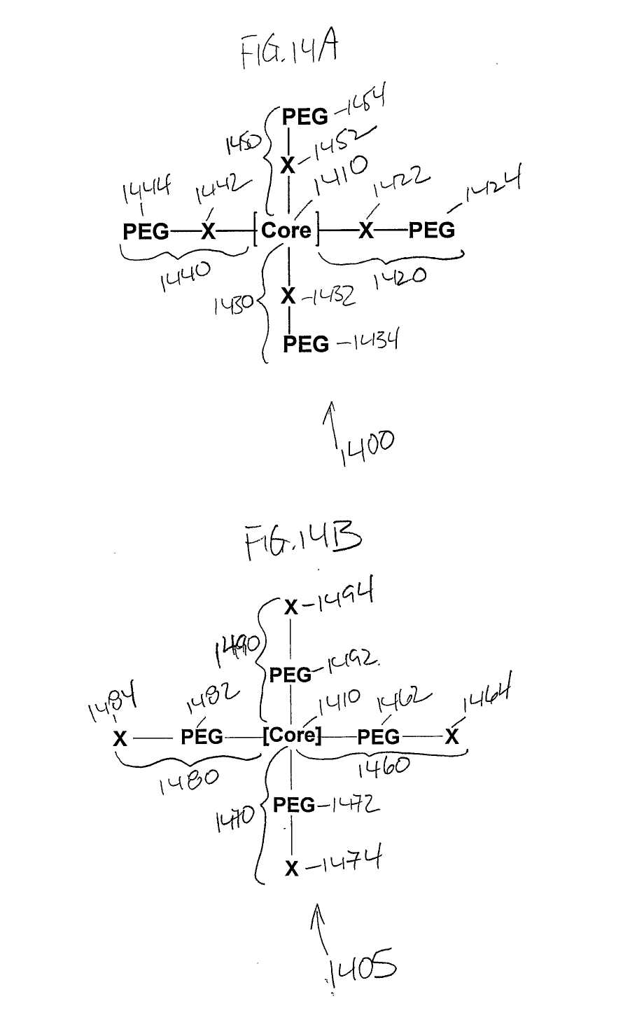

For example and referring to FIG. 14A, star polymer 1400 comprises a core material 1410 in combination with branches 1420, 1430, 1440, and 1450. As those skilled in the art will appreciate, star polymer 1400 comprises 4 arm star polymer.

In the illustrated embodiment of FIG. 14A, branch 1420 comprises a block copolymer which includes an “X” block 1422 interconnecting core 1410 and a PEG moiety 1424, as described above. In other embodiments, branch 1420 comprises a random copolymer. In other embodiments, branch 1420 comprises a homopolymer.

In the illustrated embodiment of FIG. 14A, branch 1430 comprises a block copolymer which includes an “X” block 1432 interconnecting core 1410 and a PEG moiety 1434, as described above. In other embodiments, branch 1430 comprises a random copolymer. In other embodiments, branch 1430 comprises a homopolymer.

In the illustrated embodiment of FIG. 14A, branch 1440 comprises a block copolymer which includes an “X” block 1442 interconnecting core 1410 and a PEG moiety 1444, as described above. In other embodiments, branch 1440 comprises a random copolymer. In other embodiments, branch 1440 comprises a homopolymer.

In the illustrated embodiment of FIG. 14A, branch 1450 comprises a block copolymer which includes an “X” block 1452 interconnecting core 1410 and a PEG moiety 1454, as described above. In other embodiments, branch 1450 comprises a random copolymer. In other embodiments, branch 1450 comprises a homopolymer.

In certain embodiments, “X” blocks 1422, 1432, 1442, and 1452, each comprise substantially the same composition with substantially the same molecular weight. In other embodiments, one or more of “X” blocks 1422, 1432, 1442, and 1452, differ in composition, molecular weight, or both.

In certain embodiments, PEG moieties 1424, 1434, 1444, 1454, each comprise substantially the same molecular weight. In certain embodiments, one or more of PEG moieties 1424, 1434, 1444, 1454, comprise differing molecular weights.

Referring now to FIG. 14B, star polymer 1405 comprises a core material 1410 in combination with branches 1460, 1470, 1480, and 1490. As those skilled in the art will appreciate, star polymer 1405 comprises 4 arm star polymer.

In the illustrated embodiment of FIG. 14B, branch 1460 comprises a block copolymer which includes a PEG moiety 1462, as described above, interconnecting core 1410 and an “X” block 1464. Branch 1470 comprises a block copolymer which includes a PEG moiety 1472, as described above, interconnecting core 1410 and an “X” block 1474. Branch 1480 comprises a block copolymer which includes a PEG moiety 1482, as described above, interconnecting core 1410 and an “X” block 1484. Branch 1490 comprises a block copolymer which includes a PEG moiety 1492, as described above, interconnecting core 1410 and an “X” block 1494.

In certain embodiments, PEG moieties 1462, 1472, 1482, 1492, each comprise substantially the same molecular weight. In certain embodiments, one or more of PEG moieties 1462, 1472, 1482, 1492, comprise differing molecular weights.

In certain embodiments, “X” blocks 1464, 1474, 1484, and 1494, each comprise substantially the same composition with substantially the same molecular weight. In other embodiments, one or more of “X” blocks 1464, 1474, 1484, and 1494, differ in composition, molecular weight, or both.

The number of “branches” or “arms” in Applicants' star polymers range from about 3 to 50, with from about 3 to 30 being preferred, and from about 3 to 12 branches or arms being more preferred. Even more preferably, the star polymers contain from about 4 to 8 branches or arms, with either about 4 arms or about 8 arms being still more preferred, and about 4 arms being particularly preferred. Preferred branched polymers may contain from about 3 to about 50 branches or arms (and all combinations and subcombinations of ranges and specific numbers of branches or arms therein). As noted above, preferred branched polymers may have from about 4 to 40 branches or arms, even more preferably from about 4 to 10 branches or arms, and still more preferably from about 3 to 8 branches or arms.

In one embodiment, one or more arms comprise a block copolymer with an inner, more hydrophobic block and an outer, more hydrophilic block. In preferred embodiments, the inner block is selected from the group comprising polypropylene oxide (PPO), polylactide (PLA), polylactide-coglycolide (PLGA), b-polycaprolactone, and mixtures therof, and the outer block is selected from the group comprising polyethylene glycol, PEG-PPO, PEG-PLA, PEG-PLGA, PEG-b-polycaprolactone, polyvinyl acetate, polyvinyl alcohol, polyvinyl pyrrolidine, and mixtures thereof. In certain embodiments, targeting ligands may be attached to the outermost portion of the arms.

In certain reverse block copolymer embodiments, one or more arms comprise a block copolymer with an inner, more hydrophilic block as described above, and an outer, more hydrophobic block as described above. In certain embodiments, targeting ligands may be attached to the outermost portion of the arms.

In certain embodiments, the one or more block copolymers of step 1310 are selected the polymers recited in Tables I, II, III, IV, V, VI, and/or VII, where those one or more block copolymers have number average molecular weights from about 10,000 to about 40,000 daltons. In certain embodiments, the one or more block copolymers of step 1310 have a number average molecular weight of about 10,000 daltons and a polydispersity of about 0.1. U.S. patent application having Ser. No. 10/456,193, entitled “Methods Of Making Pharmaceutical Formulations For The Delivery Of Drugs Having Low Aqueous Solubility,” describes methods to formulate such block copolymers into pharmaceutical products, and is hereby incorporated herein by reference.

The materials listed in Tables I, II, III, IV, V, VI, and VII, are available from Polymer Source, Inc., 124 Avro Street, Dorval Montreal, Quebec H9P 2X8, Canada.

TABLE I

| | |
|---|---|
| P3144-4EOLA | Four Arm Poly(Ethylene oxide-b-Lactide); 2.5/0.4 |
| P3447-4EOLA | Four Arm Poly(Ethylene oxide-caprolactone); 2.5/1.6 |
| P3152-4EOLA | Four Arm Poly(Ethylene oxide-b-Lactide,(DL form)); |
| | 2.5/0.5 |
| P3648-4LAEO | Four Arm Poly(Lactide-b-Ethylene oxide); 2.5/1.6 |
| .P5025-4CLEO | Four Arm Poly(e-Caprolactone-b-Ethyleneoxide); 4/2.0 |

TABLE II
Four-Arm Poly(lactide-b-ethylene oxide), Pentaerythritol Core

| | Mn × 103 | |
|---|---|---|
| Product No | of Branch (PLA-PEO) | Mw/Mn |
| P3648-4LAEO(D, L) | 3*-2.0 | 1.11 |
| P5026-4LAEO(D, L) | 4*-2.0 | 1.12 |

TABLE III
Four-Arm Poly(ethylene oxide-b-lactide), Pentaerythritol Core

| | Mn × 103 | |
|---|---|---|
| Product No | of Branch (PEO-PLA) | Mw/Mn |
| P3681-4EOLA(DL-form) | 0.1-0.7 | 1.10 |
| P3928-4EOLA(D-form) | 0.2-2.0 | 1.08 |
| P3152-4EOLA(DL-form) | 2.5-0.5 | 1.07 |
| P3140-4EOLA(L-form) | 2.5-0.8 | 1.15 |
| P3161-4EOLA(DL-form) | 2.5-1.6 | 1.07 |
| P3164-4EOLA(DL-form) | 2.5-3.7 | 1.15 |
| P3166-4EOLA(DL-form) | 2.5-5.5 | 1.30 |

TABLE IV
Four-Arm Poly(ethylene oxide-b-ε-caprolactone),
Pentaerythritol Core

| | Mn × 103 | |
|---|---|---|
| Product No | of Branch (PEO-PCL) | Mw/Mn |
| P3447 | 4EOCL 2.5 | 0.5 1.10 |
| P3136 | 4EOCL 2.5 | 2.7 1.19 |
| P3131 | 4EOCL 2.5 | 6.0 1.20 |
| P3132 | 4EOCL 2.5 | 11.5 1.09 |

TABLE V
Four-Arm Poly(ε-caprolactone-b-ethylene
oxide), Pentaerythritol Core

| | Mn × 103 Mw/M | |
|---|---|---|
| Product No | of Branch (PCL-PEO) | Mw/Mn |
| P5025-4CLEO | 4*-2.0 | 1.12 |

TABLE VI
Four-Arm Poly(ethylene oxide-b-lactide), Pentaerythritol Core

| | Mn × 103 | |
|---|---|---|
| Product No | of Branch (PEO-PLA) | Mw/Mn |
| P3681-4EOLA(DL-form) | 0.1-0.7 | 1.10 |
| P3928-4EOLA(D-form) | 0.2-2.0 | 1.08 |
| P3152-4EOLA(DL-form) | 2.5-0.5 | 1.07 |
| P3140-4EOLA(L-form) | 2.5-0.8 | 1.15 |
| P3161-4EOLA(DL-form) | 2.5-1.6 | 1.07 |
| P3164-4EOLA(DL-form) | 2.5-3.7 | 1.15 |
| P3166-4EOLA(DL-form) | 2.5-5.5 | 1.30 |

TABLE VII
Four-Arm Poly(lactide-b-ethylene oxide), Pentaerythritol Core

| | Mn × 103 | |
|---|---|---|
| Product No. | of Branch (PLA-PEO) | Mw/Mn |
| P3648-4LAEO(D, L) | 3*-2.0 | 1.11 |
| P5026-4LAEO(D, L) | 4*-2.0 | .12 |

Referring again FIG. 13, in step 1320, Applicants' method disposes the one or more block copolymers of step 1310 in a container. In certain embodiments, the container of step 1310 comprises vessel 310 (FIGS. 2B, 2C), described above.

In step 1330, Applicants' method introduces one or more fluorine-containing gases into the vessel containing the one or more block copolymers. In certain embodiments, step 1330 includes placing one or more vessels containing the one or more block copolymers in a chamber, which chamber may be pressurized, and introducing the fluorine-containing gas into that chamber such that the head space of the vessel is filled with that fluorine-containing gas. In certain embodiments, step 1330 includes evacuating, i.e. reducing the pressure in, the chamber containing those one or more vessels before introduction of the fluorine-containing gas therein. In certain embodiments, step 1330 includes sequentially evacuating the chamber and thereafter introducing fluorine-containing gas into that chamber having a reduced internal pressure (N) times, wherein (N) is greater than or equal to 1 and less than or equal to about 4.

In certain embodiments, the fluorine-containing gas comprises one or more perfluorocarbons. In certain embodiments, those one or more perfluorocarbons are selected from the group consisting of perfluoropropane, perfluorobutane, perfluoropentane, and perfluorohexane. In certain embodiments, the fluorine-containing gas comprises sulfur hexafluoride in combination with one or more perfluorocarbons.

In step 1340, Applicants' method disposes a pharmaceutically-acceptable carrier into the vessel containing the one or more block copolymers and the one or more fluorine-containing gases. The pharmaceutically acceptable aqueous-based carrier of step 1260 may comprise water, buffer, normal saline, physiological saline, a mixture of water, glycerol, and propylene glycol or a mixture of saline, glycerol, and propylene glycol where the components of the mixtures are in a ratio of 8:1:1 or 9:1:1, v:v:v, a mixture of saline and propylene glycol in a ratio of 9:1, v:v, and the like.

In step 1350, Applicants' method disperses the one or more block copolymers of step 1310 in the pharmaceutically-acceptable carrier of step 1340 to form Applicants' microsphere-forming composition. In certain embodiments, step 1340 includes agitating the vessel containing the one or more block copolymers, the pharmaceutically-acceptable carrier, and the one or more fluorine-containing gases. In certain embodiments, steps 1340 and 1350 are performed synchronously.

In step 1360, the method forms Applicants' gas-filled microsphere composition. In certain embodiments, step 1360 includes agitating the vessel containing Applicants' microsphere-forming composition and the one or more fluorine-containing gases. In certain embodiments, steps 1340, 1350, and 1360, are performed synchronously.

In certain embodiments, steps 1350 and 1360 comprise end-user operations, wherein those steps are performed just prior to clinical use of Applicants' gas-filled microsphere composition. In certain embodiments, steps 1340, 1350, and 1360, comprise end-user operations, wherein those steps are performed just prior to clinical use of Applicants' gas-filled microsphere composition.

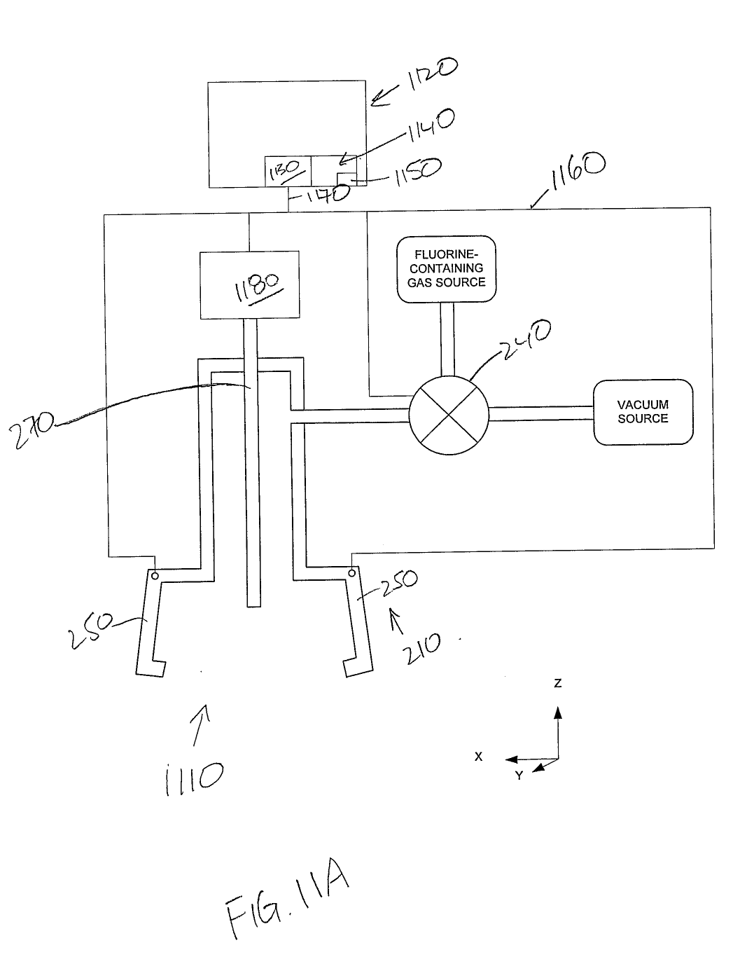

In certain embodiments of Applicants' method, step 190 (FIG. 1), and/or step 1250 (FIG. 12), and/or step 1330 (FIG. 13), include the steps recited in FIG. 10. Referring now to FIG. 10, in step 1005 Applicants' method provides a gas/vacuum assembly. In certain embodiments and referring to FIG. 2A, step 1005 includes providing apparatus 210 which is capable of releaseably fixturing Applicants' container, such as vessel 310, and which is capable of introducing one or more gases into that container, such as for example into, inter alia, head space 350. As those skilled in the art will appreciate, head space 350 comprises that interior volume of vessel 310 not comprising Applicants' microsphere-forming composition of step 160 (FIG. 1) or Applicants' lyophilized lipid composition of step 1230 (FIG. 12), or the one or more block copolymers of step 1310 (FIG. 13).

In the illustrated embodiment of FIG. 2A, apparatus 210 includes gas source 220, vacuum source 230, valve 240 and fixturing mechanism 290. Gas source 220 is capable of providing fluorine-containing gas 215. Gas source 220 is interconnected with valve 240 by conduit 225. Vacuum source 230 is interconnected with valve 240 by conduit 235. Valve 240 is interconnected with fixturing mechanism 290 by conduit 245.

Fixturing mechanism 290 includes moveable member 270 and, in certain embodiments, stopper 280 releaseably attached to the distal end of member 270. By “stopper,” Applicants mean any material which when disposed in aperture 340 forms an air tight seal. Such a stopper may comprise one or more elastomeric materials, such as for example a silicone rubber, a polyurethane, natural rubber, and the like. Such a stopper may comprise one or more rigid materials, such as for example glass. Such a stopper may comprise one or more elastomeric materials in combination with one or more rigid materials. Regardless of the construction, stopper 280 is dimensioned to be disposed in aperture 340 (FIG. 2B) to form an air-tight seal.

Referring now to FIG. 2D, in certain embodiments of Applicants' apparatus and method includes fixturing mechanism 291 which does not include stopper 280 releaseably affixed to member 270. Rather in these embodiments, stopper 282 is disposed within aperture 340 in the first orientation shown in FIG. 2D. In certain embodiments, stopper 282 includes disk portion 284 and a plurality of members which are not attached to one another, such as members 286 and 288, attached to disk 284 and extending downwardly therefrom. In the first orientation shown in FIG. 2C, members 286 and 288 are inserted into aperture 340 such disk portion 284 does not seal aperture 340. Rather in the first orientation of FIG. 2D, stopper 282 is disposed in aperture 340 such that two rectangular apertures 345 allow enclosed space 350 to communicate with the ambient environment.

Optionally, Applicants' fixturing apparatus 291 includes hardware and software to verify the proper positioning of stopper 282 in the first orientation of FIG. 2D. In certain embodiments, Applicants' fixturing apparatus includes a video assembly that is capable of capturing an image of the vessel/stopper combination to verify the proper positioning of stopper 282 in the first orientation. In certain embodiments, Applicants' fixturing apparatus includes one or more light emitting devices in combination with one or more light detecting devices, such that those devices in combination can determine if stopper 282 is properly disposed in vessel 310 in the first orientation.

In certain embodiments, Applicants' method verifies the proper orientation of stopper 282 in the first position in step 1010 (FIG. 10). In these embodiments, Applicants' method proceeds if the method determines in step 1010 that stopper 282 is properly disposed in vessel 310, and ends if stopper is not properly disposed in vessel 310. In other embodiments, the verification data of step 1010 is logged and reviewed at a later time for QA/QC purposes.

FIG. 2E shows stopper 282 disposed within aperture 340 in a second orientation. In the second orientation of FIG. 2E, stopper 282 has been further inserted into aperture 340 (FIG. 2B) with reference to the first orientation of FIG. 2D, such that disk portion 284 forms an air-tight seal with vessel 310. In this second orientation of stopper 282, enclosed space 350 does not communicate with the ambient environment.

Fixturing mechanism 290, shown in cross section in FIG. 2B, further includes moveable assembly 250 which includes flange 260 attached thereto and extending inwardly therefrom. Flange 260 is dimensioned for removable insertion into groove 330 such that flange 260 in combination with groove 330 (FIG. 2B) forms an air-tight seal. In certain embodiments, flange 260 comprises one or more elastomers.

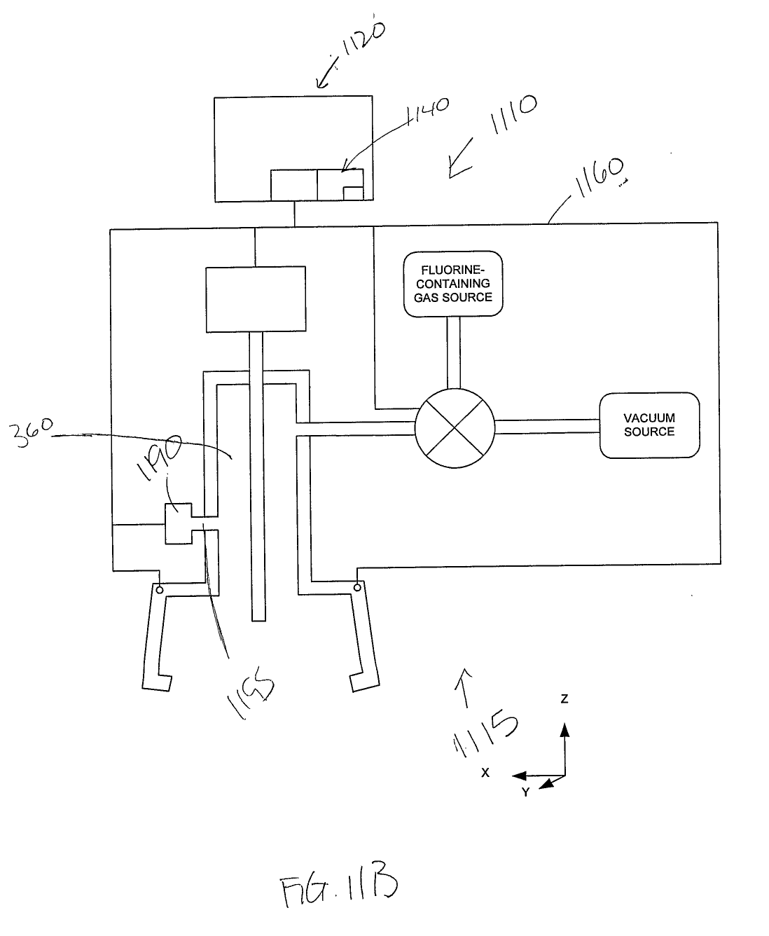

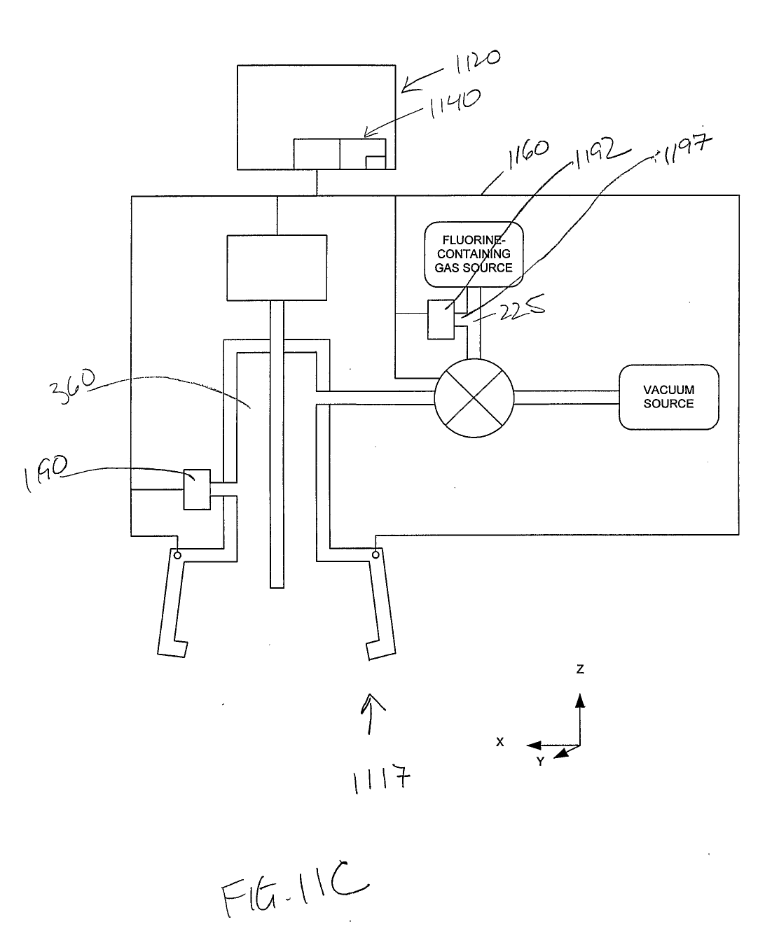

Referring now to FIGS. 10 and 11A, in certain embodiments step 1005 includes providing apparatus 1110. Apparatus 1110 includes apparatus 210 (FIG. 2A) in combination with computing device 1120, actuator 1180, and control network 1160. Computing device 1120 includes, without limitation, processor 1130 and memory 1140. As those skilled in the art will appreciate, computing device 1120 may optionally include other elements/devices, such as and without limitation one or more data input devices such as a keyboard, mouse, and the like, one or more data output devices such as a monitor, printer, and the like, one or more communication devices such as a modem, a network interface, and the like. In certain embodiments, computing device further includes operating system 1150. In other embodiments, computing device 1150 includes microcode 1140. In either event, operating system/microcode 1140 includes instructions/functions used by processor 1130 to operate apparatus 1110.

Computing device 1120 communicates with network 1160 via communication link 1170. In certain embodiments, communication link 1170 is selected from the group consisting of a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, communication link 180 is compliant with one or more of the embodiments of IEEE Specification 802.11 (collectively the “IEEE Specification”). As those skilled in the art will appreciate, the IEEE Specification comprises a family of specifications developed by the IEEE for wireless LAN technology. h

Actuator 1180 comprises a device, such as for example a solenoid, which is capable of moving member 270 bidirectionally in the Z direction. Computing device 1120 communicates with actuator 1180, valve 240, and moveable assembly 250 via network 1160. Using network 1160, computing device 1120 is capable of causing moveable arm 250 to move bidirectionally in the X direction, and is further capable of rotating valve 240 in the XZ plane.

In certain embodiments, network 1160 comprises a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed as is known to those of skill in the art.

Referring now to FIGS. 10 and 11B, in certain embodiments step 1005 includes providing apparatus 1115. Apparatus 1115 ncludes the elements of Apparatus 1110 in combination with pressure/vacuum transducer 1190. Transducer 1190 communicates with processor 1120 via network 1160. Transducer 1190 provides pressure data to processor 1120 and memory 1140 via network 1160. Transducer 1190 communicates with enclosed space 360, including head space 350, via conduit 1195. In these embodiments, transducer 1190 measures the pressure of enclosed space 360.

Referring now to FIG. 11C, in certain embodiments Applicants' gas/vacuum apparatus 1117 includes a plurality of pressure transducers which are capable of independently monitoring and logging the pressure of head space 360 and conduit 225. Apparatus 1117 includes the elements of apparatus 1115 in combination with pressure transducer 1192. Transducer 1192 communicates with conduit 225 via conduit 1197. Transducer 1192 communicates with processor 1120 via network 1160. Transducer 1192 provides pressure data to processor 1120 and memory 1140 via network 1160.

FIGS. 2A, 11A, 11B, and 11C, show Applicants' gas/vacuum assembly 210, 1110, 1115, and 1117, respectively, comprising one fixturing mechanism 190 (FIG. 2A) or 191 (FIG. 2D). In other embodiments, Applicants' gas/vacuum assembly includes a plurality of fixturing mechanisms each interconnected to one or more vacuum sources and to one or more gas sources. In embodiments, Applicants' gas/vacuum assembly comprises (M) fixturing mechanisms, wherein (M) is greater than or equal to 2.

In certain embodiments, (M) is 2. In certain embodiments, (M) is 4. In certain embodiments, (M) is 8. In certain embodiments, (M) is 16. In certain embodiments, (M) is 50. In certain embodiments, (M) is 100. In certain embodiments, (M) is 200.

In embodiments that include (M) fixturing mechanisms, Applicants' method synchronously performs steps 1010 (FIG. 10), 1020 (FIG. 10), 1030 (FIG. 10), 1040 (FIG. 10), 1050 (FIG. 10), and 1060 (FIG. 10), (M) times using (M) containers. In certain embodiments, the (M) individual fixturing mechanism are arranged in an X/Y array, wherein X comprises the number of columns of mechanisms and Y represents the number of individual fixturing mechanisms in each of those X columns.

For example in a 10/20 array, (M) equals 200, where those 200 fixturing mechanisms are arranged in 10 columns where each column includes 20 fixturing mechanisms.

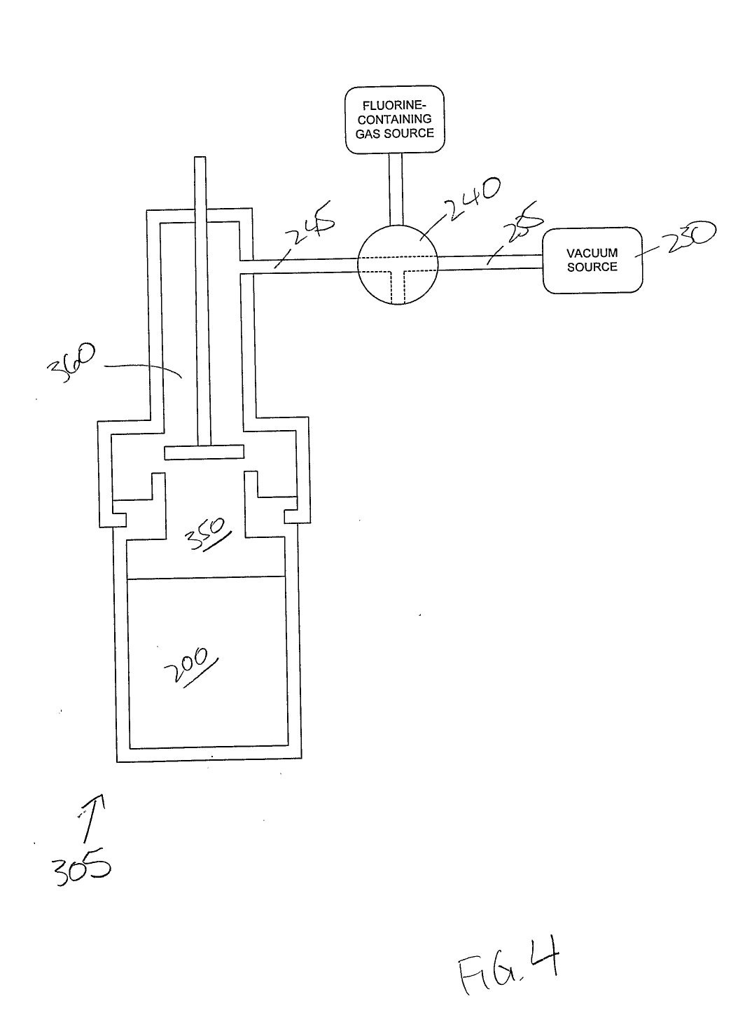

Referring again to FIG. 10, in step 1010 Applicants' method releaseably attaches the container of step 180 (FIG. 1), such as vessel 310 (FIG. 2B), to Applicants' gas/vacuum assembly, such as for example apparatus 210 (FIG. 2A) or apparatus 1110 (FIG. 11A), or apparatus 1115 (FIG. 11B). The illustrated embodiment of FIG. 3 shows vessel 310 releaseably affixed to apparatus 210. In this embodiments, flange 260 (FIG. 2A) seats within groove 330 (FIG. 2B) to form an air-tight seal and to define enclosed space 360. Enclosed space 360 includes head space 350. By “air-tight seal,” Applicants mean that if assembly 305 is disposed in ambient air at normal atmospheric pressure, and if the pressure within enclosed space 360 is reduced to a pressure of about 1 mm Hg for about 1 minute, no ambient air will enter enclosed space 360 around flange 260.

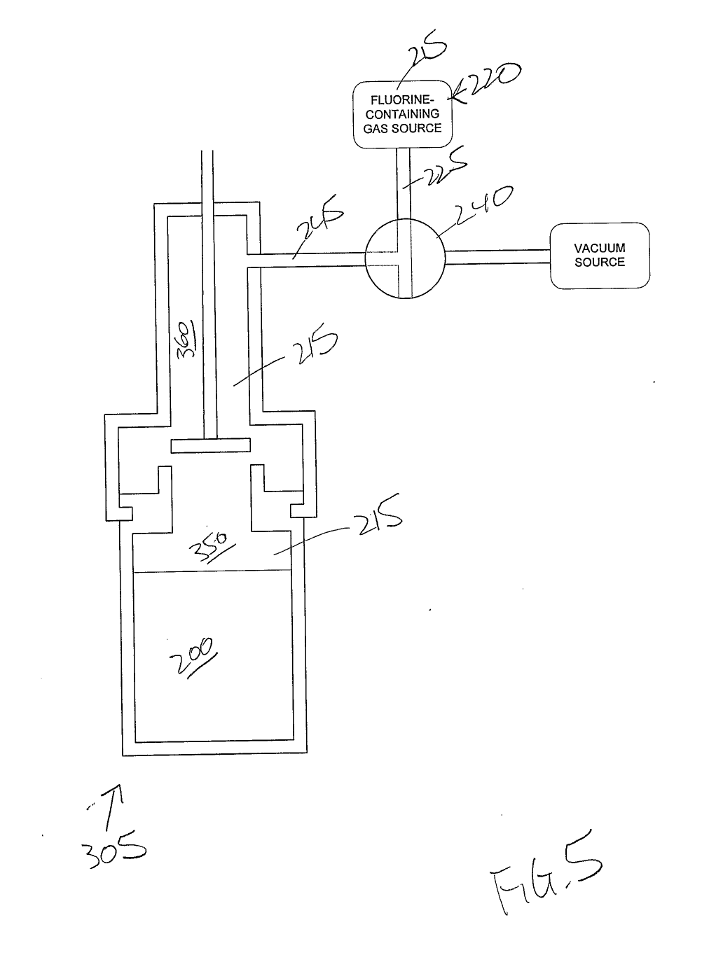

In step 1020, Applicants' method reduces the pressure in the vessel, such as vessel 310, containing Applicants' microsphere-forming composition of step 160 (FIG. 1), or Applicants' lipid composition of step 1230 (FIG. 12), or the one or more block copolyiners of step 1310 (FIG. 13). The illustrated embodiment of FIG. 4 shows valve 240 adjusted such that vacuum source 230 communicates with assembly 305 via conduits 235, valve 240, and conduit 245. FIG. 4 shows valve 240 comprising what is sometimes referred to as a “3 way valve.” As a general matter, valve 240 may comprise any device capable of selectively coupling conduit 245 to conduit 225, and selectively coupling conduit 245 to conduit 235, and selectively closing conduit 245.

In certain embodiments, step 1020 includes reducing the pressure of enclosed space 360, including head space 350, to about 50 mm Hg or less. In certain embodiments, step 1020 includes reducing the pressure of enclosed space 360, including head space 350, to about 10 mm Hg or less. In certain embodiments, step 1020 includes reducing the pressure of enclosed space 360, including head space 350, to about 0.10 mm Hg or less.

As those skilled in the art will appreciate, reducing the pressure of enclosed space 360 removes substantially all of the extant ambient air from enclosed space 360, including head space 350. In addition, reducing the pressure of enclosed space 360 also removes substantially all of the dissolved gases in Applicants' microsphere-forming composition of step 160 (FIG. 1), or Applicants' lyophilized lipid composition of step 1230 (FIG. 12), or the one or more block copolymers of step 1310 (FIG. 13). In certain embodiments, step 1020 includes reducing the pressure of enclosed space 360, including head space 350, for about 10 seconds. In certain embodiments, step 1020 includes reducing the pressure of enclosed space 360, including head space 350, for about 30 seconds. In certain embodiments, step 1020 includes reducing the pressure of enclosed space 360, including head space 350, for about 60 seconds. In certain embodiments, step 1020 includes reducing the pressure of enclosed space 360, including head space 350, for longer than 60 seconds.

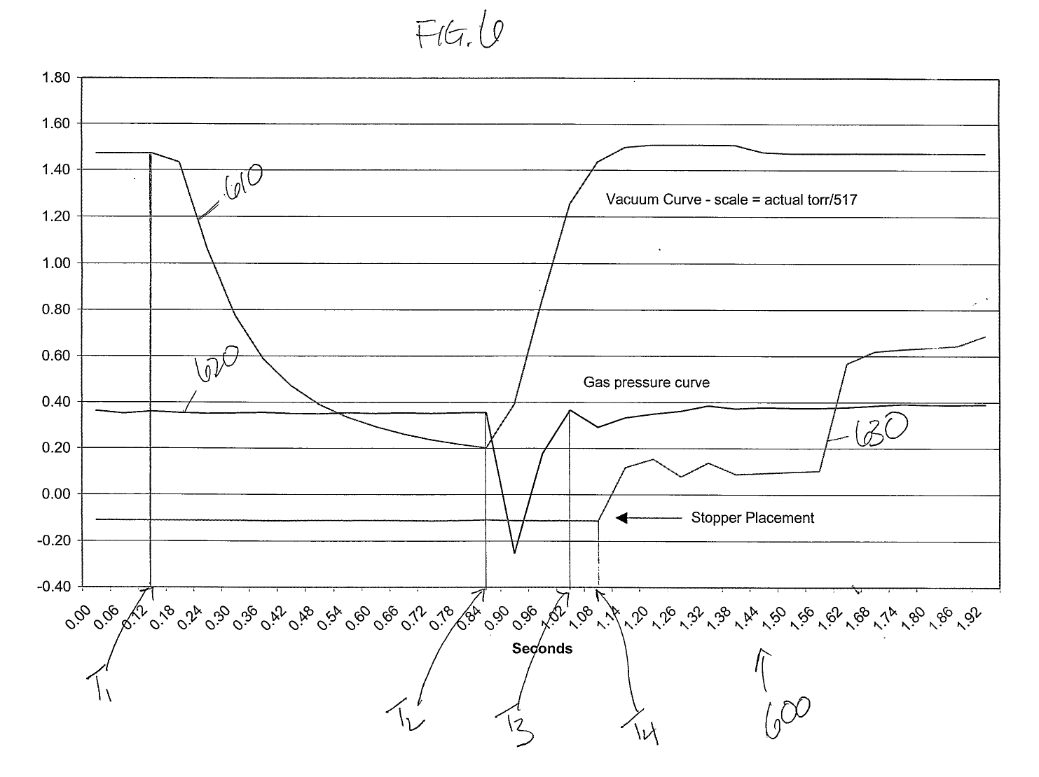

After first applying vacuum to enclosed space 350 in step 1020 Applicants' method transitions from step 1020 to step 1040 wherein the method introduces the afore-described fluorine-containing gas 215 (FIG. 2A) into enclosed space 360, including head space 350. The illustrated embodiment of FIG. 5 shows valve 240 adjusted such that gas source 220 communicates with enclosed space 350 via conduit 225, valve 240, and conduit 245. When valve 240 is so adjusted fluorine-containing gas 215 flows from source 220 into enclosed space 360, including head space 350. In certain embodiments, source 220 comprises a cylinder housing a compressed fluorine-containing gas 215. In certain embodiments, source 220 comprises a plurality of interconnected cylinders each containing gas 215. In certain embodiments, source 220 provides that fluorine-containing gas 215 at a pressure of about 2200 pounds per square inch (“PSI”).

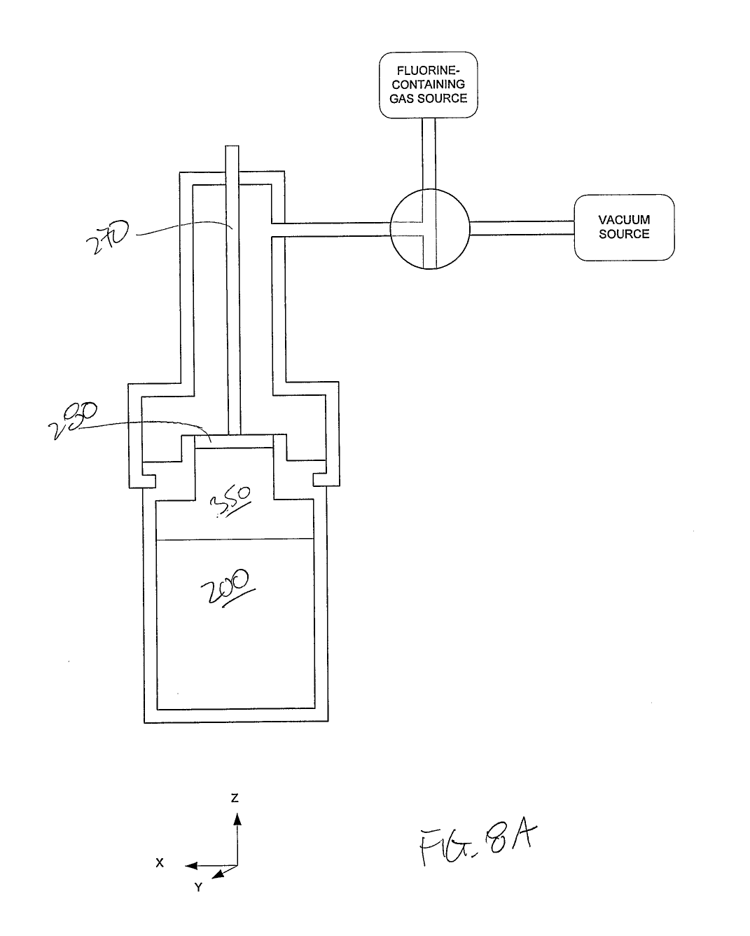

In certain embodiments, Applicants' method transitions from step 1040 to step 1050. In other embodiments, Applicants' method transitions from step 1040 to step 1020 wherein the method again reduces pressure in the vessel containing Applicants' microsphere-forming composition in the manner described above. In certain of these embodiments, Applicants' method includes step 1030 wherein the method recovers the fluorine-containing gas exhausted from enclosed space 360 when the pressure is reduced. For example and referring now to FIG. 7, in certain of the embodiments wherein Applicants' method reduces pressure in the vessel after first introducing the fluorine-containing gas into that vessel, Applicants' gas/vacuum apparatus includes fluorine-containing gas recovery apparatus 710. In certain embodiments, apparatus 710 includes a trap disposed in a bath of liquid nitrogen. In other embodiments, apparatus 710 includes a trap surrounded by dry ice. In certain embodiments, apparatus 710 includes a trap surrounded by a mixture of dry ice in methanol. In certain embodiments, apparatus 710 includes a trap surrounded by a mixture of dry ice in acetone. In other embodiments, apparatus 710 comprises an apparatus used in commerce to recover Freon gases.

In embodiments wherein Applicants' gas/vacuum apparatus includes fluorine-containing gas recovery apparatus, steps 1020 and 1030 are performed substantially synchronously. The recovered fluorine-containing gas is later removed from the recovery apparatus and stored for later use.

Applicants' method transitions from step 1030 to step 1040 wherein the method again introduces a fluorine-containing gas into the vessel containing Applicants' microsphere-forming composition as described above. In certain embodiments, Applicants' method performs steps 1020 and 1040 (N) times, and step 1030 (N-1) times. In certain embodiments, (N) is 1. In certain embodiments, (N) is 2. In certain embodiments, (N) is 3. In certain embodiments, (N) is 4. In certain embodiments, (N) is greater than 4.

Introducing fluorine-containing gas into head space 350 using prior art gas-incorporating apparatus and methods, such as for example placement of one or more open vessels in a single chamber, evacuating that chamber, and filling that chamber with a fluorine-containing gas, results in disposing only about 0.5 percent, or less, of the delivered fluorine-containing gas into the aggregate head space of those one or more vessels. Therefore using prior art apparatus and methods, about 99.5 percent, or more, of the delivered fluorine-containing gas is never used to form gas-filled microspheres. For economic reasons, as much of that unused fluorine-containing gas is recovered. Such gas recovery requires use of relatively large gas recovery units with the accompanying operating and overhead expenses, and despite the best of efforts, results in significant loss of fluorine-containing gas. As those skilled in the art will appreciate, the fluorine-containing gas many times comprises the most expensive starting material(s) used in the process to form fluorine gas-filled microspheres.

In marked contrast, using Applicants' apparatus 210 (FIG. 2A), or 1110 (FIG. 11A), or 1115 (FIG. 11B), or 1117 (FIG. 11C), and Applicants' method of FIG. 10 as described herein, more than 90 weight percent of the delivered fluorine-containing gas is incorporated into enclosed space 350, and later actually used to form gas-filled microspheres. In comparison to use of prior art apparatus and methods, Applicants' apparatus and method: (i) require the handling of less fluorine-containing gas to form an equivalent amount of gas-filled microspheres, (ii) require less expensive gas recovery units, (iii) release less fluorine-containing gas to the environment, and (iv) provide a safer workplace environment, while producing a high quality product at a lower cost.

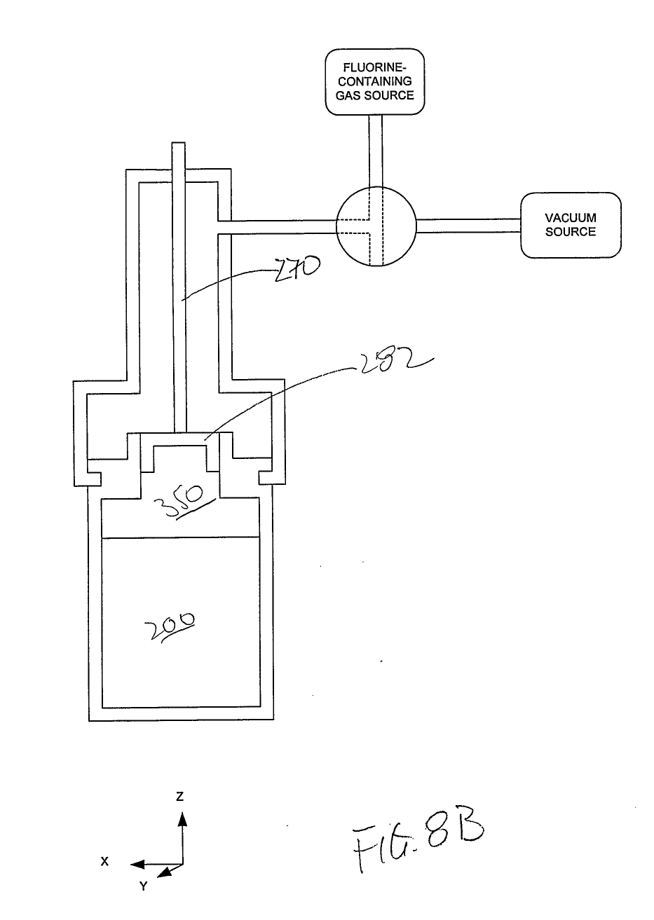

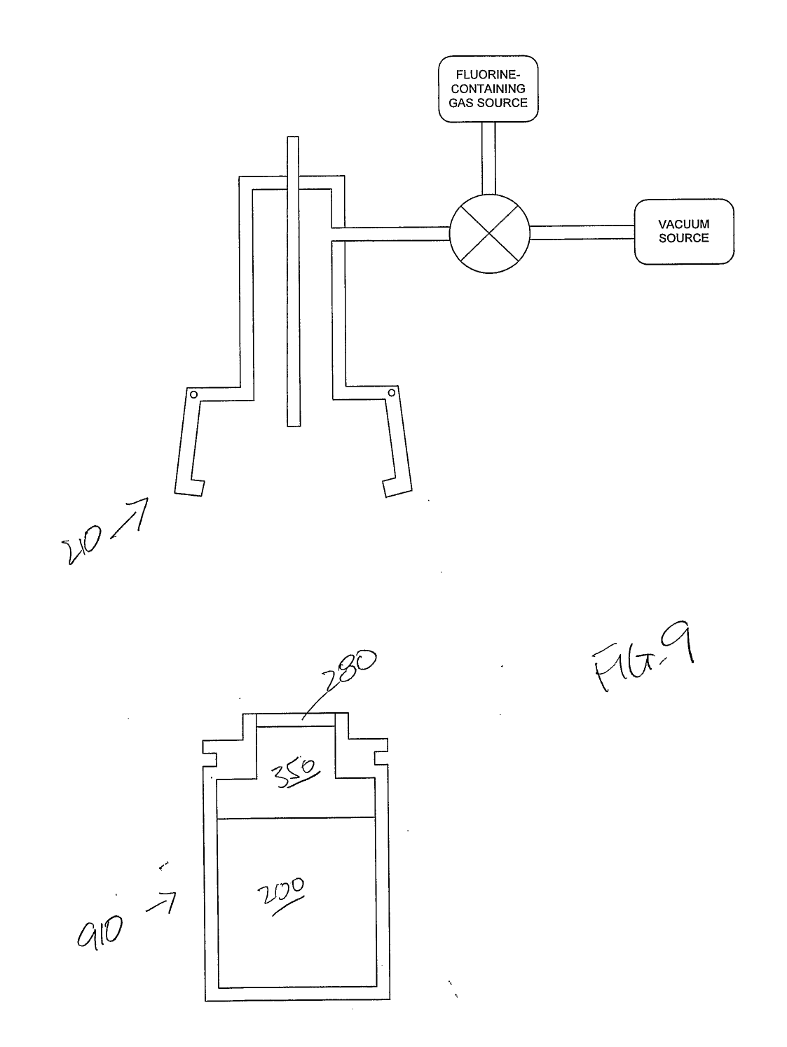

After performing steps 1020 and 1040 (N) times, and step 1030 (N-1) times, Applicants' method transitions from step 1040 to step 1050 wherein Applicants' method seals the vessel containing Applicants' microsphere-forming composition in combination with the fluorine-containing gas. In the illustrated embodiment of FIG. 8A, step 1080 includes advancing member 270 in the -Z direction to dispose stopper 280 in aperture 340 (FIG. 2B) to seal vessel 310 which contains Applicants' microsphere-forming composition in combination with the fluorine-containing gas, wherein head space 350 comprises the fluorine-containing gas.

In the illustrated embodiment of FIG. 8B, step 1080 includes advancing member 270 in the -Z direction to move stopper 282 from the first orientation shown in FIG. 2D to the second orientation shown in FIG. 2E thereby sealing vessel 310 which contains Applicants' microsphere-forming composition in combination with the fluorine-containing gas, wherein head space 350 comprises the fluorine-containing gas.

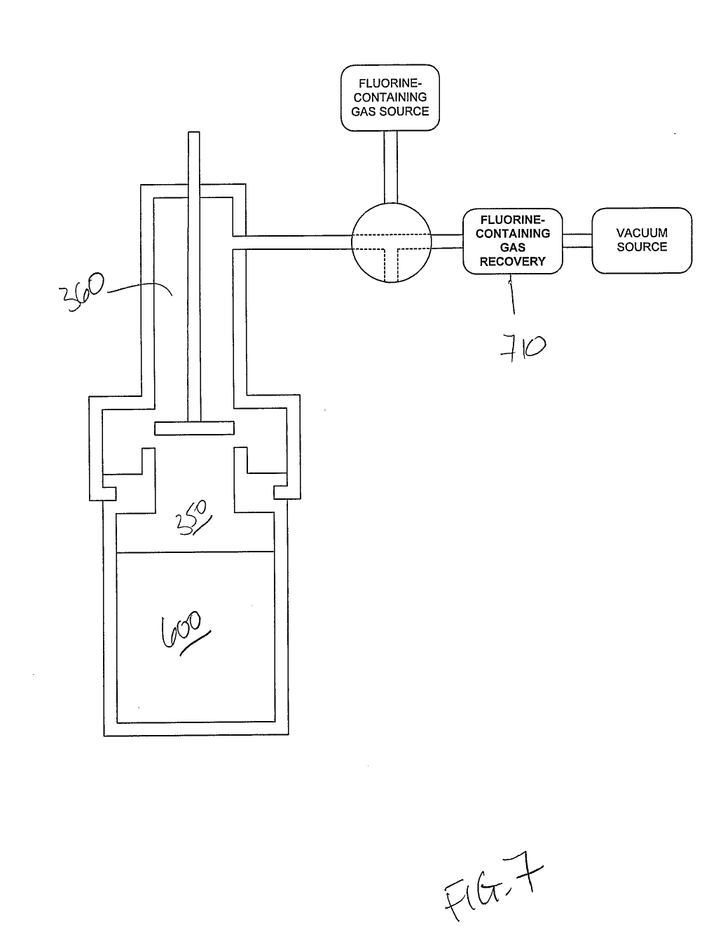

Referring now to FIG. 6, graph 600 shows pressure curve 610 for enclosed space 360, pressure curve 620 for conduit 225, and pressure curve 630 for member 270. Graph 600 can be generated using, for example, apparatus 1117 (FIG. 11C). Referring to FIG. 6, at time T₁ and in step 1020, valve 240 is adjusted to introduce a vacuum into enclosed space 360, including head space 350. Curve 610 shows the pressure of enclosed space 360 decreasing from time T₃ to time T₂.

At time T₂ and in step 1040, valve 240 is adjusted to introduce the fluorine-containing gas into enclosed space 360, including head space 350. Curve 620 shows the pressure in conduit 225 dropping between time T₂ and time T₃ as the fluorine-containing gas fills the previously evacuated enclosed space 360. At time T₃, the pressure within space 360 has equilibrated with the pressure in conduit 225, i.e. enclosed space 360, including head space 350, has been filled with fluorine-containing gas. At time T₄, curve 630 shows the pressure on member 270 increasing as member 270 urges stopper 280 or stopper 282 into aperture 340 (FIG. 2B) to seal vessel 310.

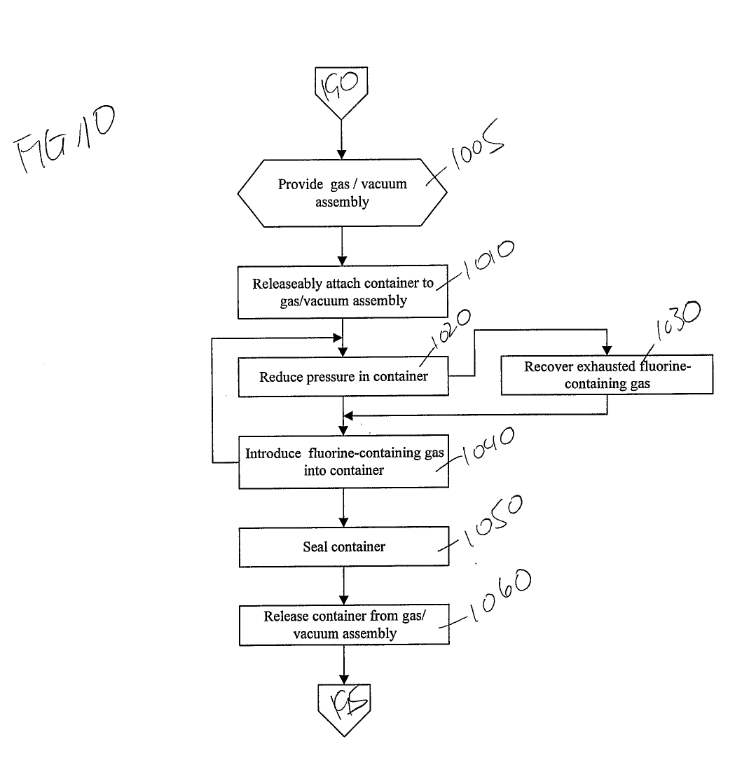

Referring now to FIG. 9, Applicants' method transitions from step 1080 to step 1090 wherein the method releases vessel 910 which includes stopper 280/282 and Applicants' microsphere-forming composition of step 160 (FIG. 1), or Applicants' lyophilized lipid composition of step 1230 (FIG. 12),or the one or more block copolymers of step 1310, in combination with the fluorine-containing gas, wherein head space 350 comprises the fluorine-containing gas.

Prior to clinical use, an end-user performs step 195. In certain embodiments, step 195 further includes “sizing” Applicants' gas-filled microsphere composition, wherein the plurality of gas-filled microspheres are physically separated by size. U.S. Pat. No. 6,033,646 describes such sizing, and is hereby incorporated by reference herein.

While the preferred embodiments of the present invention have been illustrated in detail, it should be apparent that modifications and adaptations to those embodiments may occur to one skilled in the art without departing from the scope of the present invention.

We claim:

1. A method to prepare a microsphere-forming composition, comprising the steps of:
providing a carbon-containing first solvent, wherein said first solvent does not comprise water;
providing a second solvent comprising water;
providing (N) phosphorus-containing compounds, wherein (N) is greater or equal to than 2;
forming a first mixture by mixing seriatim each of said (N) phosphorus-containing compound with said first solvent;
forming a second mixture comprising said second solvent and sodium chloride;
combining said first mixture and said second mixture to form said microsphere-forming composition.

2. The method of claim 1, wherein said first solvent comprises propylene glycol.

3. The method of claim 2, wherein (N) is 3, and wherein said providing (N) phosphorus-containing compounds step further comprises providing dipalmitoylphosphatidylcholine, dipalmitoylphosphatidylethanolaminepolyethylene glycol, and dipalinitoylphosphatidic acid.

4. The method of claim 3, wherein said dipalmitoylphosphatidylethanolaminepolyethylene glycol comprises a polyethylene glycol (PEG) moiety having a number average molecular weight about 5,000 daltons.

5. The method of claim 3, wherein said providing (N) phosphorus-containing compounds step further comprises providing (N) phosphorus-containing compounds comprising between about 3 weight percent and about 10 weight percent dipalmitoylphosphatidic acid, between about 35 weight percent and about 50 weight percent dipalmitoylphosphatidylethanolaminepolyethylene glycol, and between about 47 weight percent and about 65 weight percent dipalmitoylphosphatidylcholine.

6. The method of claim 5, wherein said forming step further comprises:
adding said dipalmitoylphosphatidic acid to said propylene glycol to form a DPPA/propylene glycol mixture;
adding dipalmitoylphosphatidylcholine to said DPPA/propylene glycol mixture to form a DPPC/DPPA/propylene glycol mixture;
adding said dipalmitoylphosphatidylethanolaminepolyethylene glycol to said DPPC/DPPA/propylene glycol mixture.

7. The method of claim 6, wherein said forming step further comprises:
disposing about 100 mL of propylene glycol in a first vessel;
placing first vessel in an oil bath maintained at 60° C.±5° C.;
adding about 60 milligrams of DPPA to the heated propylene glycol;
after dissolution of the DPPA, adding about 540 milligrams of DPPC to the heated propylene glycol solution;
after dissolution of the DPPA, adding about 400 milligrams of DPPE-PEG5000 to the heated propylene glycol solution;
after dissolution of the DPPE-PEG5000, stirring the heated propylene glycol solution at 3500 revolutions per minute for 5 minutes;
disposing about 850 mL of water in a second vessel;
placing second vessel in an oil bath maintained at 60° C.±5° C.;
adding about 50 mL of glycerol to heated water in second vessel;
mixing the water/glycerol mixture using a magnetic stir bar for about 15 minutes;
adding about 4.87 grams of sodium chloride to heated water/glycerol mixture;
adding about 2.34 grams of sodium phosphate monobasic to the heated sodium chloride/water/glycerol mixture;
adding about 2.16 grams of sodium phosphate dibasic to the heated sodium phosphate monobasic/sodium chloride/water/glycerol mixture;
stirring the aqueous mixture until dissolution of all added salts;
adding the contents of the first vessel to the heated second vessel with stirring to form the microsphere-forming composition;

8. The method of claim 1, further comprising the step of sterilizing said microsphere-forming solution.

9. The method of claim 8, wherein said sterilizing step further comprises aseptically filtering said microsphere-forming composition.

10. The method of claim 9, further comprising the steps of:
providing a sterile container; and
disposing said sterilized microsphere-forming composition in said sterile container.

11. A method to form a microsphere-forming composition, comprising the steps of:
supplying a microsphere-forming composition;
providing (M) containers, wherein each of said (M) containers comprises an enclosed volume, and wherein (M) is greater than or equal to 2;
disposing said microsphere-forming composition in each of said (M) containers, such that the enclosed volume in each of said (M) containers comprises said microsphere-forming composition and head space;
providing a gas/vacuum assembly (M) fixturing mechanisms;
providing and interconnecting a vacuum source with said gas/vacuum assembly;
providing and interconnecting a source of one or more fluorine-containing gases with said gas/vacuum assembly;
releaseably attaching each of said (M) containers to a different one of said (M) fixturing mechanisms, such that (i)th fixturing device forms an air-tight seal with the (i)th container, wherein (i) is greater than or equal to 1 and less than or equal to (M);
reducing the pressure in said gas/vacuum assembly and in each of said (M) containers;
introducing said one or more fluorine-containing gases into said gas/vacuum assembly and into the head space of each of said (M) containers, wherein more than 90 weight percent of said introduced fluorine-containing gas is disposed in said (M) containers; and
synchronously sealing each of said (M) containers.

12. The method of claim 11, wherein the series of steps comprising said reducing the pressure step and said introducing said fluorine-containing gas step is repeated (N) times, wherein (N) is greater than 1.

13. The method of claim 12, wherein (N) is 4.

14. The method of claim 11, wherein said gas/vacuum assembly comprises a fluorine-containing gas recovery device disposed between said vacuum source and said (M) fixturing mechanisms, further comprising the step of recovering in said recovery device one or more fluorine-containing gases not disposed in one of said (M) containers.

15. The method of claim 11, wherein said providing one or more fluorine-containing gases step further comprises providing a gas selected from the group consisting of a perfluorocarbon gas, a hydrofluorocarbon gas, and or sulfur hexafluoride.

16. The method of claim 15, wherein said providing one or more fluorine-containing gases step further comprises providing perfluoropropane.

17. The method of claim 15, wherein said providing one or more fluorine-containing gases step further comprises providing perfluorobutane.

18. The method of claim 11, wherein said supplying step further comprises the steps of:
providing a carbon-containing first solvent, wherein said first solvent does not comprise water;
providing a second solvent comprising water;
providing (N) phosphorus-containing compounds, wherein (N) is greater or equal to than 2;
forming a first mixture by mixing seriatim each of said (N) phosphorus-containing compound with said first solvent;
forming a second mixture comprising said second solvent and sodium chloride;
combining said first mixture and said second mixture to form said microsphere-forming solution.

19. The method of claim 18, wherein (N) is 3, and wherein said providing (N) phosphorus-containing compounds step further comprises providing dipalmitoylphosphatidylcholine, dipalmitoylphosphatidylethanolaminepolyethylene glycol, and dipalmitoylphosphatidic acid.

20. The method of claim 11, wherein said supplying step further comprises supplying a microsphere-forming composition comprising one or more block copolymers.
